(19) United States
(12) Patent Application Publication
(10) Pub. No.: US 2015/0363935 A1
(43) Pub. Date: Dec. 17, 2015

(54) ROBOT, ROBOTIC SYSTEM, AND CONTROL DEVICE

(71) Applicant: Seiko Epson Corporation, Tokyo (JP)

(72) Inventor: Masaki MOTOYOSHI, Shiojiri (JP)

(21) Appl. No.: 14/736,814

(22) Filed: Jun. 11, 2015

(30) Foreign Application Priority Data
Jun. 12, 2014 (JP) 2014-121217

(51) Int. Cl. G06T 7/00; G06T 1/00

(52) U.S. Cl. CPC G06T 7/0046; G06T 1/0014

(57) ABSTRACT

A robot includes an arm adapted to move an object, an input reception section adapted to receive input of information (information of a control point in an object coordinate system in a restricted sense) defined by a coordinate system set to the object, and a control section adapted to make the arm operate based on a taken image obtained by imaging the object and the information input.

### BACKGROUND

1. Technical Field

The present invention relates to a robot, a robotic system, a control device, and so on.

2. Related Art

There has been known visual servo control for obtaining an image in real time to control a robot based on the information of the image. As the visual servo control, there are used a position-base method and a feature amount-base method in terms of a general classification.

In the feature amount-base method, the information regarding how the feature amount of the image (an amount representing a feature such as an area in the image, the area of the image, the length of a line segment, or the position of a feature point) varies when moving the object is made to directly correspond to an action to operate the robot. In this method, there is an advantage that, for example, the robot can be operated even in the case in which the accuracy of a calibration between a camera and the robot is low.

In JP-A-2012-130977 (Document 1), for example, there is described an operation method of avoiding hardware restrictions in the feature amount-base visual servo control.

In Document 1, there is no description regarding how the feature amount, which is the information used for the control, is set. Therefore, similarly to the typical feature amount-base method, it results that the information characteristic for the image such as a line segment corresponding to an edge of the object or a point corresponding to an angle is used as the feature amount. In other words, in the related art method described in Document 1 and so on, it is difficult to use a point and so on not very characteristic for the image as the feature amount.

### SUMMARY

An aspect of the invention relates to a robot including an arm adapted to move an object, an input reception section adapted to receive input of information defined by a coordinate system set to the object, and a control section adapted to make the arm operate based on a taken image obtained by imaging the object and the information input.

According to the aspect of the invention, the information in the coordinate system set to the object is received, and the arm is made to operate based on the information and the taken image. The information input is defined by the coordinate system based on the object, and can therefore be set without the restriction on whether or not the information is characteristic in the image. Thus, it becomes possible to, for example, flexibly set the controlling information used for the operation of the arm.

In the aspect of the invention, the input reception section may receive the input of the information in a screen in which a model corresponding to the object is displayed.

According to this configuration, it becomes possible to, for example, receive input of the information using an easy-to-understand interface.

In the aspect of the invention, the information may be information of a control point defined by the coordinate system set to the object.

According to this configuration, it becomes possible to, for example, receive the information of the control point to make the arm operate.

In the aspect of the invention, the control section may obtain position attitude of the object based on information of a model of the object and the taken image, obtain a feature amount by performing a coordinate conversion of the control point based on the position attitude, and make the arm operate based on the feature amount and a target feature amount.

According to this configuration, it becomes possible to, for example, obtain the feature amount used for the operation of the arm using a process of obtaining the position attitude from the model of the object and the process of performing the coordinate conversion on the control point in accordance with the position attitude.

In the aspect of the invention, the input reception section may receive input of information of a second control point defined by a second coordinate system set to a second object, and the control section may obtain position attitude of the second object based on information of a model of the second object and the taken image obtained by imaging the second object, and perform the coordinate conversion of the second control point based on the position attitude of the second object to thereby obtain the target feature amount.

According to this configuration, it becomes possible to, for example, obtain the target feature amount in a similar manner to the method described above.

In the aspect of the invention, the control section may make the arm operate so that the object and the second object have a predetermined relative positional relationship based on the feature amount and the target feature amount.

According to this configuration, it becomes possible to, for example, make the arm operate using the feature amount and the target feature amount obtained using the method described above.

In the aspect of the invention, the control section may obtain position attitude of the object based on information of a model of the object and the taken image, obtain a target feature amount by performing a coordinate conversion of the control point based on the position attitude, and make the arm operate using the target feature amount.

According to this configuration, it becomes possible to, for example, obtain the target feature amount used for the operation of the arm using a process of obtaining the position attitude from the model of the object and the process of performing the coordinate conversion on the control point in accordance with the position attitude.

In the aspect of the invention, the control section may obtain a feature amount based on the taken image obtained by imaging the second object, and make the arm operate so that the object and the second object have a predetermined relative positional relationship based on the feature amount and the target feature amount.

According to this configuration, it becomes possible to, for example, make the arm operate using the target feature amount obtained using the method described above and the feature amount obtained from the taken image.

In the aspect of the invention, the information may be information of a control point defined by the coordinate system set to the object, and the control section may obtain the position attitude of the object in a camera coordinate system set to an imaging section adapted to take the taken image based on information of a model of the object and the taken image, and obtain information of the control point in the camera coordinate system based on the position attitude in the camera coordinate system and information of at least one control point in the coordinate system set to the object.

According to this configuration, it becomes possible to obtain the information of the control point in the camera coordinate system from the information of the control point in the coordinate system set to the object and the position attitude of the object in the camera coordinate system.

In the aspect of the invention, the control section may perform perspective transformation on the control point in the camera coordinate system, and make the arm operate using information of the control point, on which the perspective transformation has been performed, as at least one of the feature amount and a target feature amount.

According to this configuration, it becomes possible to make the arm operate using the information obtained by further performing the perspective transformation on the information of the control point in the camera coordinate system.

In the aspect of the invention, the control section may make the arm operate based on a first taken image taken by a first imaging section, a second taken image taken by a second imaging section, and the information input.

According to this configuration, it becomes possible to, for example, make the arm accurately operate using the plurality of imaging sections in addition to flexibly setting the information used for the control.

Another aspect of the invention relates to a robotic system including a robot including an arm adapted to move an object, an input reception section adapted to receive input of information defined by a coordinate system set to the object, and a control section adapted to make the arm operate based on a taken image obtained by imaging the object and the information input.

According to the another aspect of the invention, the information in the coordinate system set to the object is received, and the arm is made to operate based on the information and the taken image. The information input is defined by the coordinate system based on the object, and can therefore be set without the restriction on whether or not the information is characteristic in the image. Thus, it becomes possible to, for example, flexibly set the controlling information used for the operation of the arm.

Still another aspect of the invention relates to a control device adapted to control a robot including an arm adapted to move an object, including an input reception section adapted to receive input of information defined by a coordinate system set to the object, and a control section adapted to make the arm operate based on a taken image obtained by imaging the object and the information input.

According to the still another aspect of the invention, the information in the coordinate system set to the object is received, and the arm is made to operate based on the information and the taken image. The information input is defined by the coordinate system based on the object, and can therefore be set without the restriction on whether or not the information is characteristic in the image. Thus, it becomes possible to, for example, flexibly set the controlling information used for the operation of the arm.

As described above, according to some aspects of the invention, by increasing the degree of freedom in setting the information used for the control, it is possible to provide a robot, a robotic system, a control device, and so on each performing the flexible control of an arm and so on.

### BRIEF DESCRIPTION OF THE DRAWINGS

The invention will be described with reference to the accompanying drawings, wherein like numbers reference like elements.

FIGS. 1A through 1D are diagrams each showing an example of setting of control points and an example of the feature amount.

FIG. 2 is a diagram showing a configuration example of a robot according to the embodiment of the invention.

FIG. 3 is a diagram showing a configuration example of a typical visual servo control system.

FIG. 4 is a diagram showing an example of a structure of the robot according to the embodiment.

FIG. 5 is a diagram showing a detailed configuration example of the robot according to the embodiment.

FIG. 6 is a diagram showing another example of the structure of the robot according to the embodiment.

FIG. 7 is a diagram showing another example of the structure of the robot according to the embodiment.

FIG. 8 is a diagram showing an example of a control device according to the embodiment realized by a server.

FIG. 9 is a diagram showing an example of control points set in an object coordinate system.

FIGS. 10A and 10B are explanatory diagrams of a change in position attitude of a three-dimensional model, and a change in the object in a template image.

FIG. 11 is a diagram showing an example of the position attitude of the object in a camera coordinate system.

FIG. 12 is an explanatory diagram of a perspective transformation process.

FIG. 13 is an explanatory diagram of an assembly operation.

FIG. 14A is a diagram showing an example of a reference image, and FIG. 14B is an explanatory diagram of the fact that the position of an assembly object is shifted.

FIG. 15 is a diagram showing another detailed configuration example of the robot according to the embodiment.

FIG. 16 is a diagram showing a setting example of the control points and an example of the feature amount.

FIG. 17 is a diagram showing another example of the structure of the robot according to the embodiment.

FIGS. 18A through 18C are diagrams for explaining a change in a taken image in each imaging section with respect to the change in the position attitude of the object.

FIGS. 19A through 19C are diagrams for explaining a change in a taken image in each imaging section with respect to the change in the position attitude of the object.

FIGS. 20A through 20C are diagrams for explaining a change in a taken image in each imaging section with respect to the change in the position attitude of the object.

FIGS. 21A through 21C are diagrams for explaining a change in a taken image in each imaging section with respect to the change in the position attitude of the object.

FIGS. 22A through 22C are diagrams for explaining a change in a taken image in each imaging section with respect to the change in the position attitude of the object.

FIG. 23 is a diagram for explaining an error in position attitude estimation in an optical axis direction.

FIG. 24 is an explanatory diagram of the fact that an error range can be narrowed in the case in which a relative relationship between the imaging sections is known.

FIG. 25 is an explanatory diagram of the fact that the error range increases in the case in which the relative relationship between the imaging sections is unknown.

FIG. 26 is a diagram showing another detailed configuration example of the robot according to the embodiment.

FIG. 27 is an explanatory diagram of the error range in the case in which the perspective transformation process has been performed.

FIG. 28 is a diagram of an example of a control amount in the case in which the perspective transformation process has been performed.

FIGS. 29A and 29B are diagrams showing an example of a change of the control amount with time in the case of using the position attitude of the object as the feature amount in an environment without an error, and FIGS. 29C and 29D are diagrams showing an example of a change of the control amount with time in the case of using the information obtained by the perspective transformation as the feature amount in an environment without an error.

FIGS. 30A and 30B are diagrams showing an example of a change of the control amount with time in the case of using the position attitude of the object as the feature amount in an environment with an error, and FIGS. 30C and 30D are diagrams showing an example of a change of the control amount with time in the case of using the information obtained by the perspective transformation as the feature amount in an environment with an error.

### DESCRIPTION OF EXEMPLARY EMBODIMENTS

Hereinafter, some embodiments of the invention will be explained. It should be noted that the embodiments described below do not unreasonably limit the contents of the invention as set forth in the appended claims. Further, all of the constituents described in the embodiments are not necessarily essential elements of the invention.

### 1. Method of the Embodiment

There has been known a method of operating the robot based on the taken image obtained by imaging the object. As an example, there has been known the visual servo control for setting the object closer to the target state by using a difference (variation) between the information representing the present state of the object obtained from the taken image and the information representing the target state as the feedback information.

As the visual servo control, there are used a position-base method using the position attitude of the object as the information representing the state described above, and a feature amount-base method using some feature amount as the information. In the feature amount-base method, the feature amount (image feature amount) f is obtained from the taken image, and then a comparing process with the target feature amount f_{g} is performed. For example, it is possible that edge information representing the contour of the object is obtained from the taken image, and then the position of a vertex of the object on the image (the coordinate in the image coordinate system as a two-dimensional plane) obtained based on the edge information is used as the image feature amount. Hereinafter, the feature amount representing the current state obtained for each control loop from the taken image is also described as a control feature amount in order to clearly distinguish the feature amount from the target feature amount.

Further, regarding the target feature amount, it is also possible to obtain the target feature amount by obtaining the taken image (a reference image, a target image) in which the object is in the target state, and then detecting the feature amount from the reference image using substantially the same method. On this occasion, it is also possible to obtain the reference image only once in advance, or to continuously obtain the reference image during the visual servo control. Alternatively, it is also possible to adopt a configuration in which the target feature amount is not obtained from the reference image, but the value of the feature amount is directly obtained. For example, if it has been known that the predetermined vertex is located at the position of (x_{g}, y_{g}) on the image when the object becomes in the target state, it is sufficient to set the target feature amount f_{g} as fg=(x_{g}, y_{g}).

Although the details of the process will be described later, if the control feature amount and the target feature amount can be obtained, the control amount (e.g., a drive amount of a joint angle) for making the object approach the target state can be obtained, and therefore, it becomes possible to operate the robot.

However, in the feature amount-base visual servo control according to the related art, on the grounds that the feature amount is directly obtained from the taken image, it is necessary to use the information of a point (or an area), which is so characteristic as to be able to clearly be distinguished from other points (or other areas) in the image, as the feature amount. For example, in the case of the edge of the object, it can be extracted from the image as, for example, a set of points having pixel values (e.g., luminance values) changing dramatically, and in the case of the vertex (the corner), it can be extracted from the image as a point in the edge at which the angle of the edge changes dramatically. In other words, if either point or either side of the object is used as the calculation target of the feature amount, it is possible to directly obtain the feature amount from the image.

However, in the case in which the calculation target of the feature amount is, for example, the center point of a predetermined surface of the object, since the predetermined surface has a flat structure, the change in pixel value becomes small in the area of the image corresponding to the surface. Therefore, the difference in the image between the center point of the surface and points in the surface different from the center point fails to become clear, and it is not easy to identify the center point of the surface from the image. Of course, it is not impossible to obtain the feature amount from the center point of the predetermined surface in such a manner that the surface is identified from the edge information, and then the center point of the surface is geometrically obtained. However, in general, it can be said that it is difficult to use an uncharacteristic point on the image as the feature amount.

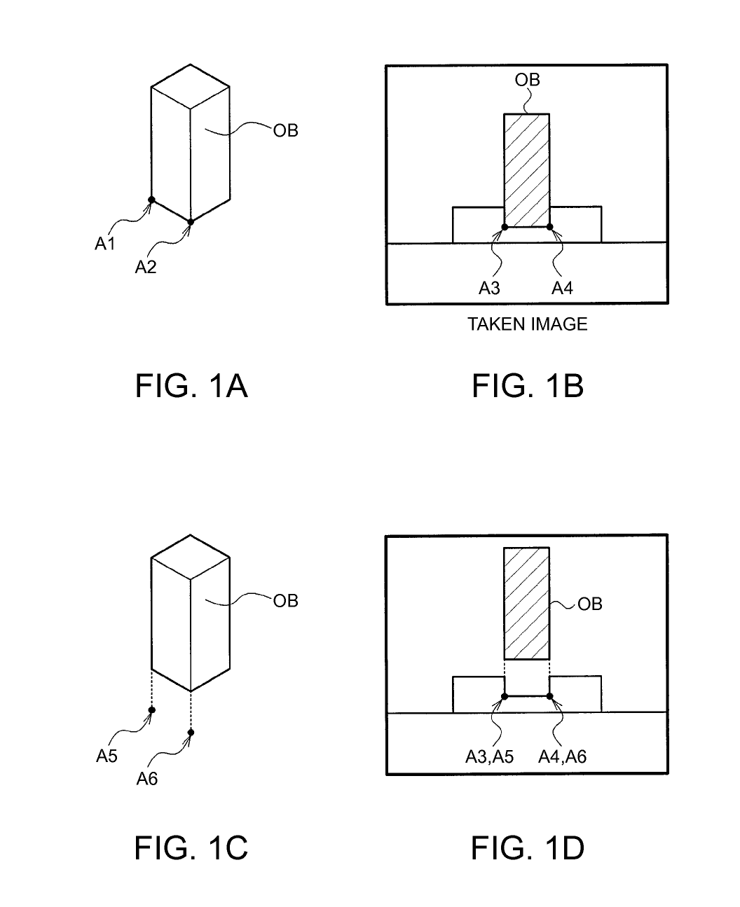

Moreover, it is also difficult to set the target (hereinafter described as a control point for the sake of explanation of an example in which the target is a point) of the calculation process of the feature amount in the outside of the object. There is considered an operation aiming to set the object OB having a rectangular solid shape shown in FIG. 1A to the position attitude shown in FIG. 1B. It should be noted that FIG. 1B shows an example of the taken image taken by the imaging section.

In this case, in the case of setting two vertexes A1 and A2 of the object shown in FIG. 1A as the control points, the target feature amounts are set to the points A3 and A4 shown in FIG. 1B. Specifically, the visual servo control is performed so as to decrease the difference between the position of the point A1 and the position of the point A3 on the image, and at the same time decrease the difference between the position of the point A2 and the position of the point A4. However, in this case, since the state in which the object has contact with another object is set as the target state, in the case in which an error occurs in the control, there occurs a possibility that the object and another object collide with each other. In the case of the example shown in FIG. 1B, if an error that the object is located at a position lower than the target occurs, the object and an object located on the lower side collide with each other, which leads to a possibility of breakage and so on.

In such a case, it is advisable to set the target feature amount to the points A3, A4, and to set the control points to the outside of the object. For example, by setting the control points to the points A5 and A6 located on the straight line obtained by extending the side of the object and on the outer side than the vertex as shown in FIG. 1C, it becomes possible to use the positions of the points A5 and A6 on the image as the control feature amounts. By adopting such a configuration, since in the visual servo control, there is performed the control of decreasing the difference between the points A5 and A3, and at the same time decreasing the difference between the points A6 and A4, the control targeting the state shown in FIG. 1D becomes possible as a result. If the state shown in FIG. 1D is the target, even if the error that the position of the object is shifted a little bit downward occurs, the possibility of the collision between the object and another object can be inhibited. It should be noted that the state shown in FIG. 1B, which is the original target state, can be obtained by moving the object immediately downward after the state shown in FIG. 1D has been realized, and can therefore be realized with the normal position control. Alternatively, it is also possible to perform new visual servo control setting the state shown in FIG. 1D as an origin, and using the vertexes themselves as the control points as shown in FIG. 1A. In this case, since it is premised that the object has sufficiently come close to another object, by taking measure such as suppressing the moving speed, it is possible to suppress the dangerousness due to the collision to realize the state shown in FIG. 1B.

In other words, although it is helpful to set the control points outside the object, such external points cannot be the characteristic points on the image. Because, it is not true that some objects actually exist at such control points, and the pixel values, variations of the pixel values, spatial frequencies, and so on fail to become peculiar compared to other points on the image. Therefore, in the feature amount-base method according to the related art, it is difficult to operate the robot using such control points as shown in FIG. 1C.

Further, in any method according to the related art, it is necessary for the control points to be imaged in the taken image irrespective of whether or not the target of the calculation process of the feature amount is characteristic in the image. For example, if the control point is one of the vertexes of the object, it is necessary for the vertex be imaged in the taken image. Specifically, it is necessary for the vertex to be directed toward the imaging section (a camera), and in the state in which the vertex is directed to the opposite side to the imaging section, the feature amount cannot be calculated. Alternatively, in the case in which another object (e.g., an arm or a hand of the robot, or a jig) gets into an area between the imaging section and the control point, the case in which the pixel value in the vicinity of the control point cannot be obtained (e.g., an error of the imaging element, a highlight detail loss or a blocked up shadow due to the condition of the irradiation with the source light), and so on, the feature amount cannot be calculated on substantially the grounds. In these cases, since the control feature amount (or the target feature amount) cannot be calculated, it results that the operation of the robot cannot be performed.

To wrap up the above, in the feature amount-base method according to the related art, there are a problem that only the characteristic point or the like in the image can be used as the feature amount (in other words, only the point having a feature in the image can be set to the control point), and a problem that the feature amount cannot be obtained unless the control point is imaged in the taken image. In particular, although it is possible to perform the flexible robot control by disposing the control point outside the object, due to the problem that the feature amount cannot be obtained unless the characteristic control point is set in the image, it is difficult to set such a control point.

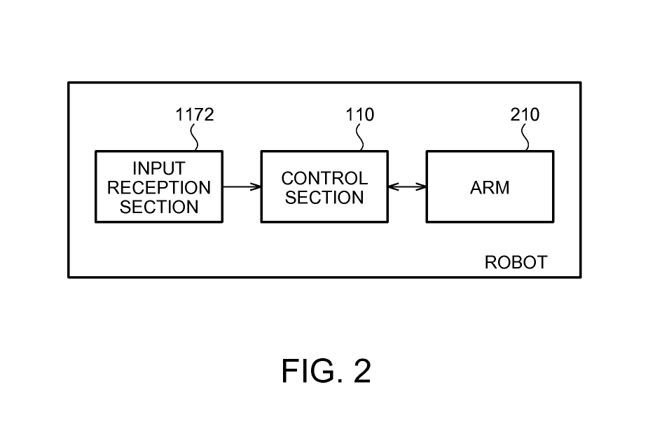

Therefore, the present applicant proposes a method capable of flexibly setting the control point. It should be noted that what is used for the calculation of the feature amount is only required to be the information set with reference to the object as the target of the operation (movement) by the robot, and is not limited to a point. Specifically, as shown in FIG. 2, the robot according to the present embodiment includes an arm 210 for moving the object OB, an input reception section 1172 for receiving input of the information defined by the coordinate system (hereinafter also described as an object coordinate system) set to the object OB, and a control section 110 for operating the arm 210 based on the taken image obtained by imaging the object OB and the information input.

Here, the information input in the input reception section 1172 can also be the information of the control point defined by the coordinate system set in the object OB. Specifically, the information input in the input reception section 1172 is the information representing an arbitrary point on the object coordinate system, and more specifically, the coordinate (Xₒ, Yₒ, Zₒ) representing a point in a three-dimensional coordinate system. Although the explanation is hereinafter presented assuming that the information to be input is the information of the control point, the information is not limited to information of a point, but can be expanded to information of a line or a plane expressed in the object coordinate system.

The information of the control point or the like input to the input reception section 1172 is the information expressed in the object coordinate system, and is therefore relative information with reference to the object. Therefore, if the position attitude of the object is figured out, it becomes possible to identify the control point based on the relative relationship with the object. In other words, if how the object is imaged in the taken image is identified, it results that how the control point having a predetermined relative relationship with the object is imaged in the taken image can be identified. On this occasion, the control point can be identified from the information input, and is therefore not required to be characteristic in the image. Further, when identifying how the object is imaged, it is sufficient for the object to be imaged with a certain level of size and resolution, and it does not matter whether or not the control point is imaged. In other words, even if the control point fails to be imaged due to the reason that, for example, the control point is shielded by another object, it is also possible to identify the position of the control point in the image in the case of assuming that the shielding object does not exist.

Therefore, according to the method of the present embodiment, it becomes possible to flexibly set the position or the like of the control point with respect to the object. Therefore, it becomes possible to, for example, inhibit the collision between the object and another object by setting the control point outside the object, and make the robot operate even in the positional relationship in which the control point is not imaged.

Here, although there can be adopted a variety of methods of identifying how the object is imaged in the taken image, it is also possible to use, for example, a three-dimensional model of the object. In this case, the control section 110 obtains the position attitude of the object based on the information of the model of the object and the taken image, then obtains the feature amount by performing the coordinate conversion of the control point based on the position attitude, and then makes the arm operate based on the feature amount and the target feature amount.

For example, if it is identified that the object is in a predetermined position attitude in the coordinate system (the camera coordinate system) set in the imaging section, how the object is imaged in the taken image obtained by the imaging section can be obtained using the three-dimensional model. Therefore, by comparing the a virtual taken image (a template image) taken using a model and the taken image actually taken with each other, the position attitude of the object with respect to the imaging section can be obtained. Specifically, it is possible to obtain a plurality of template images by variously varying the position attitude of the model, and then identify the template image most approximate to the actual taken image among these template images. Since the template image and the position attitude of the model correspond to each other, it is conceivable that the position attitude of the object corresponding to the template image thus identified coincides with the actual position attitude of the object.

It should be noted that although the visual servo control is hereinabove explained as the method of making the robot operate using the taken image obtained by imaging the object, the method according to the present embodiment is not limited to the visual servo control. For example, it is not required to perform the feedback control. Specifically, it is also possible to user a vision method of identifying the position attitude to be the target based on the taken image, and then performing the movement to the position attitude using position control. Although the visual servo control will hereinafter be explained as an example, it is possible to consider the expansion of the following explanation to other control using the taken image such as the vision method.

Hereinafter, a basic concept of the visual servo control will be explained, then a system configuration example of the robot and so on according to the present embodiment will be explained, and then first and second embodiments will be explained in detail. In the first embodiment, the basic method will be explained citing the case of providing a single imaging section. In the second embodiment, the case of providing a plurality of (two in a restricted sense) imaging sections will be explained.

### 2. Visual Servo Control System

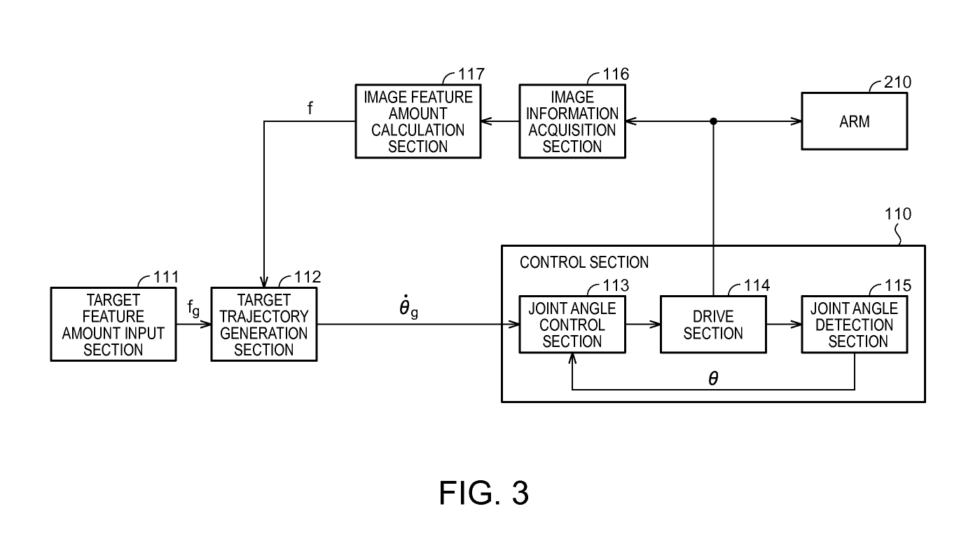

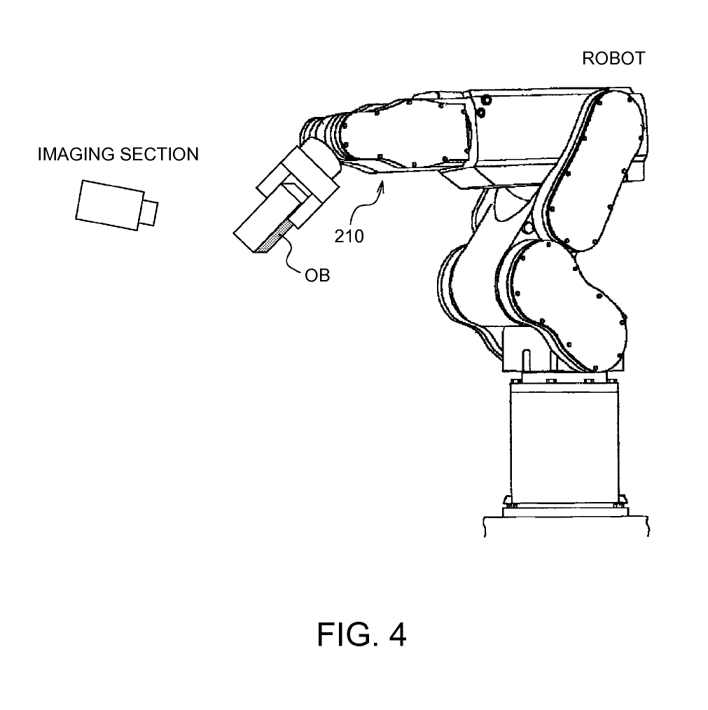

Prior to the explanation of the method according to the present embodiment, a typical visual servo control system will be explained. FIG. 3 shows a configuration example of the typical visual servo control system, and FIG. 4 shows an example of a structure of the robot. As shown in FIG. 3, the robot includes a target feature amount input section 111, a target trajectory generation section 112, a joint angle control section 113, a drive section 114, a joint angle detection section 115, an image information acquisition section 116, an image feature amount calculation section 117, and the arm 210. It should be noted that the robot according to the present embodiment described later is different in system configuration example (some blocks are added) from FIG. 3, but can substantially be the same in robot configuration as shown in FIG. 4.

The target feature amount input section 111 inputs the target feature amount f_{g} to be the target to the target trajectory generation section 112. The target feature amount input section 111 can also be realized as, for example, an interface for accepting the input of the target feature amount f_{g} by the user. In the robot control, there is performed the control of making the image feature amount f obtained from the image information close to (match, in a restricted sense) the target feature amount f_{g} input here. It should be noted that it is possible to obtain the image information (a reference image, a goal image) corresponding to the target state to obtain the target feature amount f_{g} from the image information. Alternatively, it is also possible to directly accept the input of the target feature amount f_{g} without holding the reference image.

The target trajectory generation section 112 generates the target trajectory, which is used for making the robot operate, based on the target feature amount f_{g} and the image feature amount f obtained from the image information. Specifically, the target trajectory generation section 112 performs a process for obtaining the variation Δθ_{g} of the joint angle for approximating the state of the robot to the target state (the state corresponding to the target feature amount f_{g}). The variation Δθ_{g} is used as a tentative target value of the joint angle. It should be noted that it is possible for the target trajectory generation section 112 to obtain the drive amount of the joint angle per unit time (θ_{g} attached with a dot shown in FIG. 3) from the variation Δθ_{g}.

The joint angle control section 113 performs the control of the joint angle based on the target value Δθ_{g} of the joint angle and the current value θ of the joint angle. For example, since the target value Δθ_{g} is the variation of the joint angle, the joint angle control section 113 performs the process of obtaining what value the joint angle should be set to using the current value θ and the target value Δθ_{g}.

The drive section 114 performs the control of driving the joint of the robot in accordance with the control of the joint angle control section 113.

The joint angle detection section 115 performs a process of detecting what value the joint angle of the robot is set to. Specifically, after the joint angle has been changed due to the drive control by the drive section 114, the joint angle detection section 115 detects the value of the joint angle thus changed, and then outputs the value thus detected to the joint angle control section 113 as the current value θ of the joint angle. The joint angle detection section 115 can also be realized specifically as an interface or the like for obtaining the information of an encoder.

The image information acquisition section 116 performs acquisition of the image information from the imaging section and so on. The imaging section mentioned here can be one disposed in the environment as shown in FIG. 4, or can also be an imaging section (e.g., a hand-eye camera) provided to the arm 210 or the like of the robot.

The image feature amount calculation section 117 performs arithmetic processing of the image feature amount based on the image information obtained by the image information acquisition section 116. It should be noted that although the method according to the present embodiment has a feature in the calculation method of the image feature amount (the control feature amount) as described above, since the typical visual servo control will be explained here, the explanation will be presented assuming that the image feature amount can have normally been obtained. The image feature amount having been obtained by the image feature amount calculation section 117 is output to the target trajectory generation section 112 as the latest image feature amount f.

It should be noted that since the specific processing procedure of the visual servo control has already been known widely, further detailed explanation will be omitted.

### 3. First Embodiment

The case of providing a single imaging section will be explained as a first embodiment. Specifically, the system configuration example of the robot and so on will first be explained, then the process of each of the sections of the image feature amount calculation section 117 will be explained in detail, and then some modified examples will lastly be explained.

### 3.1. System Configuration Example

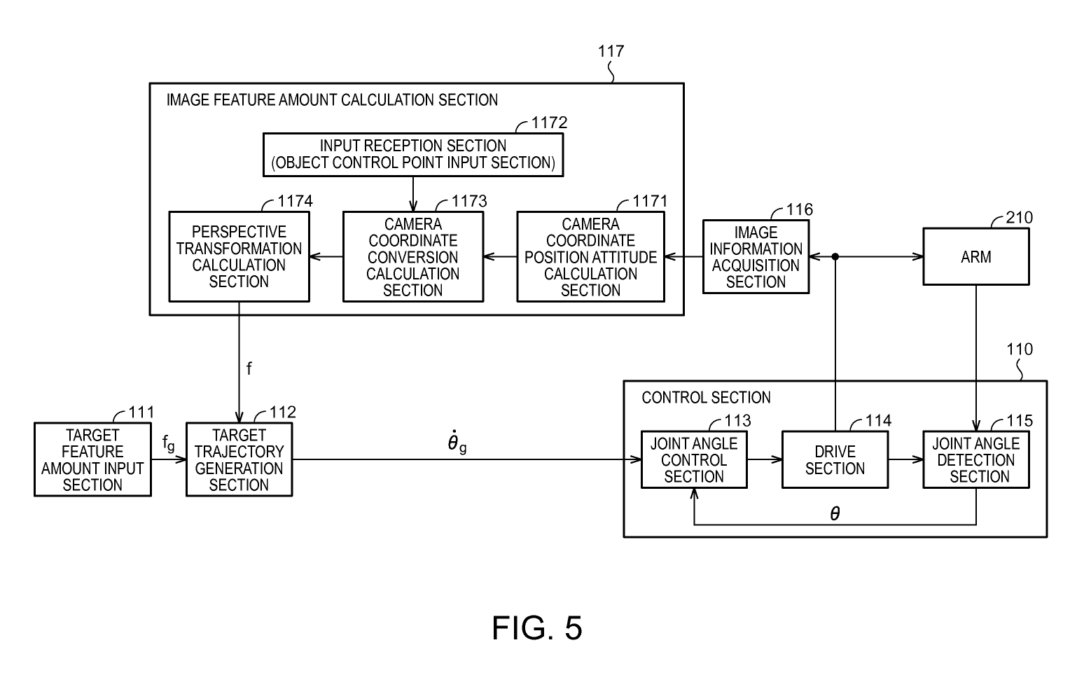

FIG. 5 shows a detailed system configuration example of the robot according to the present embodiment. It should be noted that the configuration of the robot is not limited to the configuration shown in FIG. 5, but various practical modifications such as elimination of some of the constituents or addition of other constituents are possible.

As shown in FIG. 5, the image feature amount calculation section 117 of the robot according to the present embodiment includes a camera coordinate position attitude calculation section 1171, an input reception section (an object control point input section) 1172, a camera coordinate conversion calculation section 1173, and a perspective transformation calculation section 1174.

The camera coordinate position attitude calculation section 1171 calculates the position attitude of the object in the camera coordinate system using the model of the object. The object control point input section 1172 receives the input of the information of the control point in the object coordinate system. The camera coordinate conversion calculation section 1173 calculates the information of the control point in the camera coordinate system based on the position attitude of the object in the camera coordinate system and the information of the control point in the object coordinate system. The perspective transformation calculation section 1174 transforms the information of the control point in the camera coordinate system into the information in the coordinate system (hereinafter also described as an image plane coordinate system) corresponding to a two-dimensional image plane. The details of the process performed in each of the sections of the image feature amount calculation section 117 will be described later.

It should be noted that as shown in FIG. 5, the control section 110 in FIG. 2 corresponds to the joint angle control section 113, the drive section 114, the joint angle detection section 115, and so on. It should be noted that the configuration of the control section 110 is not limited to FIG. 5, but can also include other constituents such as the target trajectory generation section 112.

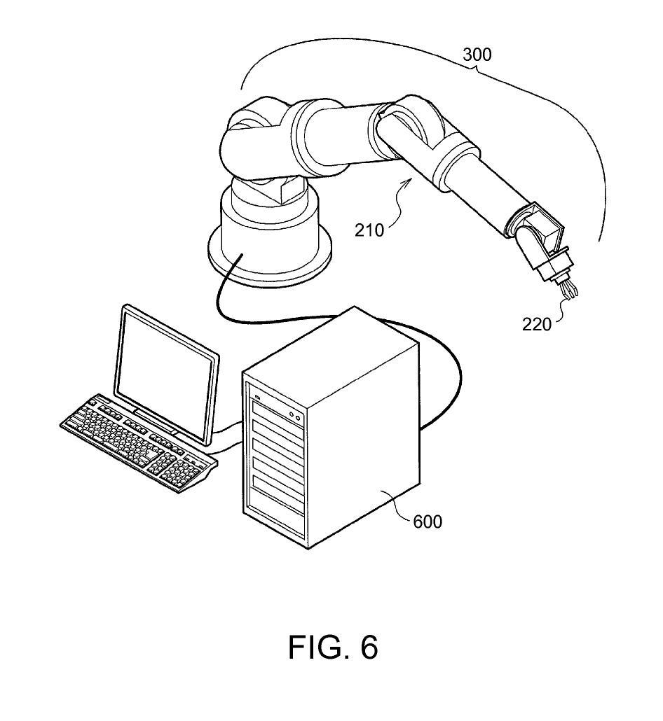

The robot according to the present embodiment can also be a robot including a control device 600 and a robot main body 300 as shown in FIG. 6. According to the configuration shown in FIG. 6, the control device 600 includes the control section 110 and so on shown in FIG. 2. Further, the robot main body 300 includes the arm 210 and an end effector 220. By adopting this configuration, it becomes possible to realize the robot flexibly setting the control point and so on.

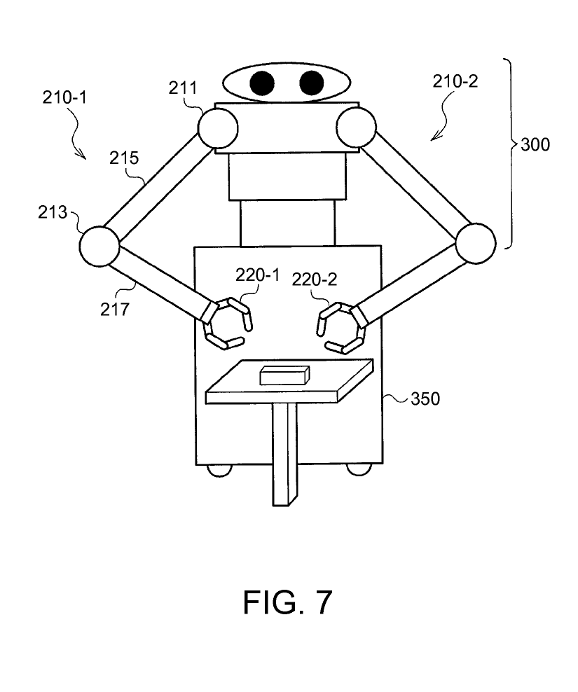

It should be noted that the configuration example of the robot according to the present embodiment is not limited to FIG. 6. For example, as shown in FIG. 7, the robot can also include the robot main body 300 and a base unit section 350. As shown in FIG. 7, the robot according to the present embodiment can also be a dual-arm robot, and includes a first arm 210-1, a second arm 210-2, a first end effector 220-1, and a second end effector 220-2 in addition to a part corresponding to a head and a body. Although in FIG. 7, it is assumed that the first arm 210-1 is constituted by joints 211, 213 and frames 215, 217 disposed between the joints, and the same applies to the second arm 210-2, the configuration is not limited to this example. It should be noted that although in FIG. 7, there is shown the example of the dual-arm robot having two arms, it is also possible for the robot to be provided with three or more arms.

The base unit section 350 is disposed below the robot main body 300 to support the robot main body 300. In the example shown in FIG. 7, the base unit section 350 is provided with wheels or the like to have a configuration allowing the whole of the robot to move. It should be noted that it is also possible to adopt a configuration in which the base unit section 350 is not provided with the wheels or the like, but is fixed to the floor or the like. Although FIG. 7 does not show a device corresponding to the control device 600 shown in FIG. 6, in the robotic system shown in FIG. 7, the base unit section 350 incorporates the control device 600, and thus the robot main body 300 and the control device 600 are integrally configured.

Alternatively, it is also possible to realize the control section 110 and so on described above with a board (more specifically, IC and so on mounted on the board) incorporated in the robot without providing particular controlling equipment such as the control device 600.

Further, the method according to the present embodiment can also be applied to the control device of the robot described above except the robot main body 300. Specifically, the method according to the present embodiment can be applied to a control device, which controls a robot having an arm for moving an object, and includes the input reception section 1172 for receiving the input of the information defined by the coordinate system set to the object, and the control section 110 for making the arm 210 operate based on the taken image obtained by imaging the object and the information thus input. The control device mentioned in this case corresponds to a part of the configuration shown in FIG. 5 except the arm 210.

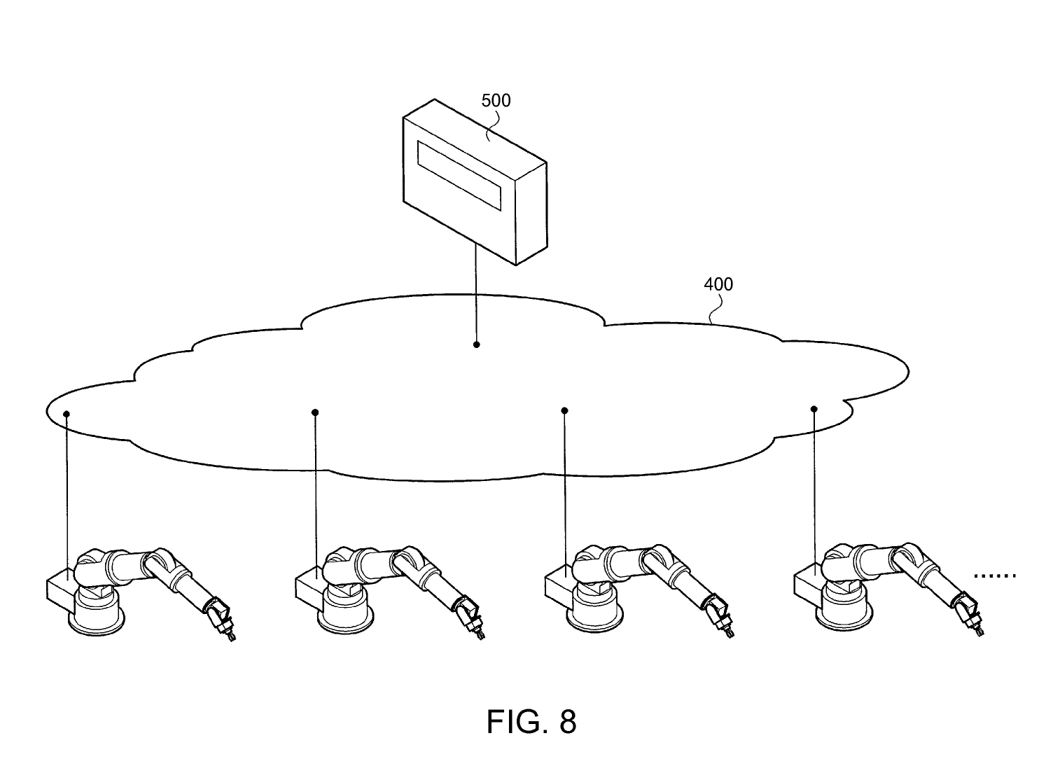

Further, the configuration of the control device according to the present embodiment can also be, but is not limited to, one denoted with the reference numeral 600 shown in FIG. 6, and the function of the control device can also be realized by a server 500 provided with communication connection with the robot via a network 400 including at least one of wired and wireless connections as shown in FIG. 8.

Alternatively, in the present embodiment, a part of the processing of the control device according to the invention can be performed by the server 500 as the control device. In this case, the processing is realized by distributed processing with a control device provided to the robot.

Further, on this occasion, the server 500 as the control device performs the process assigned to the server 500 among the processes in the control device according to the invention. Meanwhile, the control device provided to the robot performs the process assigned to the control device of the robot among the processes in the control device according to the invention.

For example, there is considered the case in which the control device according to the invention is for performing first through M^{th} (M is an integer) processes, and the first through M^{th} processes each can be divided into a plurality of sub-processes in such a manner that the first process is realized by sub-processes 1a, 1b, and the second process is realized by sub-processes 2a, 2b. In this case, it is possible to adopt a distributed processing in which the server 500 as the control device performs the sub-processes 1a, 2a, . . . , Ma, and the control device provided to the robot performs the sub-processes 1b, 2b, . . . , Mb. On this occasion, the control device according to the present embodiment, namely the control device executing the first through M^{th} processes, can also be a control device executing the sub-processes 1a through Ma, a control device executing the sub-processes 1b through Mb, or a control device executing all of the sub-processes 1a through Ma, and 1b through Mb. Moreover, the control device according to the present embodiment is a control device executing at least one sub-process with respect to each of the first through M^{th} processes.

Thus, it becomes possible for the server 500 high in processing power than the terminal device (e.g., the control device 600 shown in FIG. 6) on the robot side to perform the process heavy in processing load, for example. Further, it is possible for the server 500 to collectively control the operations of the robots, and thus, it becomes easy to make the plurality of robots perform collaborative operations, for example.

Further, in recent years, it has been increasing to manufacture a wide variety of products in small quantities. Further, in the case of changing the type of the component to be manufactured, it is necessary to change the operation performed by the robot. According to the configuration shown in FIG. 8, it becomes possible for the server 500 to collectively change the operations to be performed by the robots, for example, without performing a teaching operation to each of the plurality of robots once again. Further, it becomes possible to dramatically save the trouble in performing software update of the control device, for example, compared to the case of providing one control device to each of the robots.

Further, the method according to the present embodiment can also be applied to a robotic system including a robot having the arm 210 for moving an object, the input reception section 1172 for receiving the input of the information defined by the coordinate system set to the object, and the control section 110 for making the arm 210 operate based on the taken image obtained by imaging the object and the information thus input. It should be noted that the robotic system mentioned here can also include other constituents than these. There can be adopted a modified implementation such as inclusion of an imaging section for taking the taken image used in the control section 110.

### 3.2. Input Reception Section

Then, the details of the process of each of the sections of the image feature amount calculation section 117 according to the present embodiment will be described. The input reception section 1172 receives the input of the information defined by the object coordinate system. The information can also be the information of the control point in a restricted sense as described above. It results that the calculation of the feature amount used for the visual serve control is performed based on the information input here.

Here, in order to set the object to the target state using the visual servo control, it is desirable for the feature amount to be the information having the number of dimensions with which the state of the object can uniquely be determined. For example, in the case of uniquely determine the position attitude of the object, the feature amount is the information having the number of dimensions of about six. Therefore, it is also desirable to make the information used for the calculation of the feature amount so sufficient that the feature amount with such a number of dimensions can be calculated.

For example, as described later using FIG. 12 and so on, since in the present embodiment, the feature amount is obtained by performing the perspective transformation on the control point, the feature amount of two dimensions is required for the information of one control point. Therefore, in the case of, for example, obtaining the feature amount with the number of dimensions equal to or larger than six, it results that at least three control points are set.

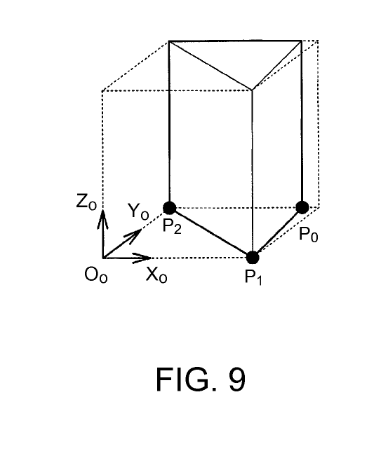

FIG. 9 shows an input example of the control point. FIG. 9 shows an example in which an object has a triangular prism shape, and an object coordinate system having one of the vertexes of the rectangular solid, with which the triangular prism has internal contact, as the origin of the coordinate system, and the sides of the rectangular solid each including the origin as the three axes of the orthogonal coordinate system is set with respect to the object. In the example shown in FIG. 9, there is performed the input for setting the control points respectively to three vertexes P₀, P₁, and P₂ constituting a triangle as the bottom surface of the triangular prism. Further, the information of the control point having been input is expressed as a coordinate in the object coordinate system described above. In the case of the example shown in FIG. 9, it results that the points P₀, P₁, and P₂ are each expressed using the coordinate value in the coordinate system defined by the Xₒ, Yₒ, and Zₒ axes and the origin Oₒ.

On this occasion, the input reception section 1172 can also receive the input of the information in the screen in which the model corresponding to the object is displayed. In the case of the example shown in FIG. 9, it is sufficient to display the model of the object having the triangular prism shape in the input screen in advance, and then receive the input regarding which point is used as the control point in the input screen. On this occasion, since in the present embodiment, the control point is not limited to the vertexes or a point on the sides as described above, it is advisable for the user to prepare an interface with which the point can flexibly be set.

For example, the attitude of the object is made flexible. This can be achieved by an interface of inputting the position attitude of the object as six-dimensional coordinate information, or inputting only the attitude information excluding the position as three-dimensional information. It should be noted that since it is difficult for the user to make a specific numerical value and the actual position attitude correspond to each other, it is also possible to realize the change in attitude using, for example, an interface of rotating the object displayed a predetermined rotational axis. Such display can be achieved by setting the model of the object in a predetermined position attitude, and then generate and display the image obtained by imaging the model with a virtual camera.

It should be noted that in the case of using a two-dimensional image as the input screen, it is not achievable to identify the position in the depth direction (the optical axis direction of the virtual camera described above). Therefore, if the flexibility in the depth direction remains, there is a possibility that a point different from the point intended by the user could be set as the control point. Therefore, it is also possible to realize an interface easy for the user to understand by limiting the point to be set as the control point to points on the surfaces constituting the object or points on planes obtained by extending such surfaces. In addition, a variety of modified implementations of the screen display and the interface used for the input can be adopted.

It should be noted that the processing in the input reception section 1172 according to the present embodiment is not limited to the example of receiving the information of the control point from the user. For example, it is possible to adopt a modified implementation of, for example, automatically generating the control point inside the robot, and then performing the process of receiving the information of such a control point.

### 3.3. Camera Coordinate Position Attitude Calculation Section

In the camera coordinate position attitude calculation section 1171, the position attitude of the object in the camera coordinate system is obtained. Specifically, the three-dimensional position attitude of the object is detected based on the taken image and three-dimensional model data as ideal three-dimensional shape information of the object. More specifically, the position attitude of the object is detected by generating a two-dimensional template image from the three-dimensional model data, and then performing a matching process between the input image (the taken image) and the template image.

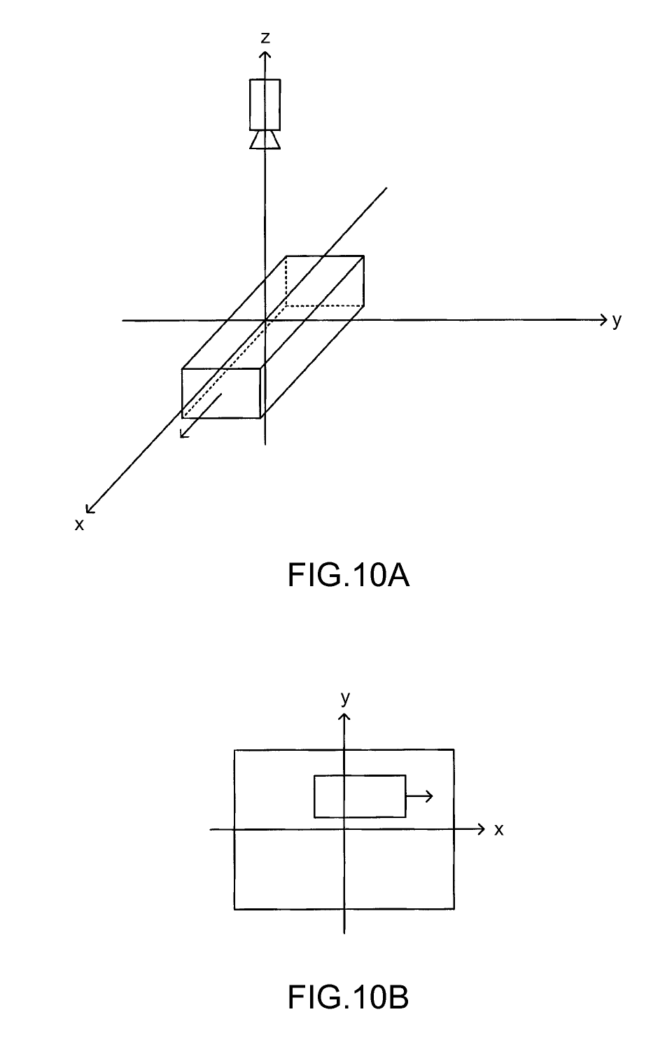

Although there can be adopted a variety of method of obtaining (generating) the template image from the three-dimensional model data, it is sufficient to use a method of disposing the virtual camera at a predetermined position on the z axis in the three-dimensional space defined by the x axis, the y axis, and the z axis as shown in FIG. 10A, for example, and then using the image obtained by taking an image in the origin direction as the template image. On this occasion, assuming that the upper direction of the template image corresponds to the positive direction of the y axis, the taken image by the virtual camera becomes the image shown in FIG. 10B. Imaging by the virtual camera is specifically realized by a perspective transformation process or the like.

On this occasion, if the position of the three-dimensional model data in the x axis is changed, it results that the object in the template image moves in the lateral direction of the image. Specifically, if the position of the object is changed toward the arrow direction shown in FIG. 10A, the object in the template image also moves toward the arrow direction. Similarly, if the position in the y axis is changed, it results that the object moves in the vertical direction of the image. Further, if the object is moved in the z-axis direction, the distance between the object and the virtual camera is changed, and therefore, the size of the object in the template image changes. Further, if the rotational angle u around the x axis, the rotational angle v around the y axis, and the rotational angle w around the z axis are changed, the attitude of the object with respect to the virtual camera changes, and therefore, it results that the shape of the object in the template image basically changes except the case in which, for example, the object has revolution symmetry. It should be noted that although it is assumed in FIGS. 10A and 10B that the virtual camera is fixed to the coordinate system, and the three-dimensional model data is moved, it is also possible to fix the object and move the virtual camera.

Specifically, when detecting the position attitude of the object using the template image obtained from the three-dimensional model data and the input image, it is sufficient to change the position attitude (x, y, z, u, v, and w) of the three-dimensional model data to thereby obtain a plurality of template images different in position, size, and shape of the object in the image from each other, and then search for the image the most approximate to the input image out of the plurality of template images. In the circumstance in which the template image and the input image are approximate to each other (coincide with each other, in a restricted sense), it is conceivable that the relative position attitude of the three-dimensional model data with respect to the virtual camera and the relative position attitude between the imaging section having taken the input image and the actual object are sufficiently approximate to each other (coincide with each other, in a restricted sense).

Since a similarity as a parameter representing how similar the two images are is normally required in the image matching, detection of the position attitude can be simplified as an issue of obtaining the position attitude (x, y, z, u, v, and w) of the three-dimensional model data maximizing the similarity. If the position attitude (x, y, z, u, v, and w) is obtained, the position attitude relationship of the actual object with respect to the imaging section having taken the input image can be obtained using the relative position attitude relationship of the three-dimensional model data with respect to the virtual camera on that occasion. Further, if the layout position attitude of the imaging section in a predetermined coordinate system is known, it is easy to, for example, convert the position attitude of the object into information of the predetermined coordinate system.

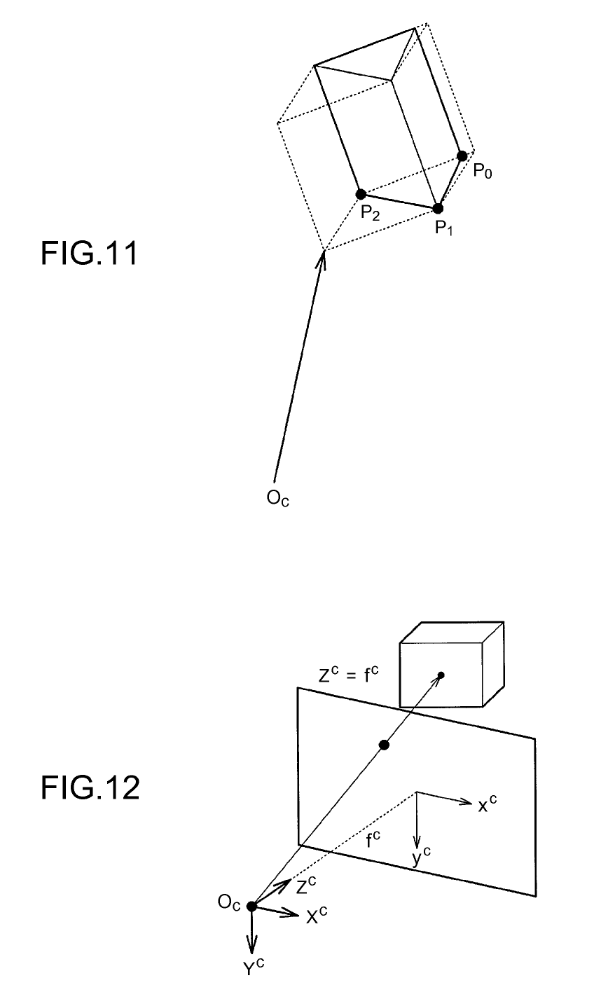

FIG. 11 shows an example of the case in which the position attitude of the object in the camera coordinate system is identified. As shown in FIG. 11, in the case in which it is known that the origin of the object coordinate system is Oₒ, the position of the object in the camera coordinate system is expressed as the position (X_{c}, Y_{c}, Z_{c}) of Oₒ with respect to the origin O_{c} of the camera coordinate system, and the attitude of the object in the camera coordinate system is expressed as a rotation (U_{c}, V_{c}, W_{c}) around the respective axes of the camera coordinate system with respect to a predetermined reference attitude.

### 3.4. Camera Coordinate Conversion Calculation Section

As described above, in the camera coordinate position attitude calculation section 1171, the position attitude of the object in the camera coordinate system is obtained, in the input reception section 1172, the information of the control point in the object coordinate system is required. Here, the information in the object coordinate system denotes relative information based on the object. In the robot control such as the visual servo control, since the control amount is determined after obtaining the current state of the object, even if the information of the control point is input, the information in the object coordinate system, which is kept constant irrespective of the state (e.g., the position attitude in the world coordinate system) of the object cannot directly be used for the control.

Therefore, the control section 110 according to the present embodiment obtains the position attitude of the object in the camera coordinate system set to the imaging section for taking the taken image based on the information of the model of the object and the taken image, and then obtains the information of the control point in the camera coordinate system based on the position attitude in the camera coordinate system and the information of one control point or a plurality of control points in the coordinate system set to the object.

Specifically, in the camera coordinate conversion calculation section 1173, the information of the control point expressed with the object coordinate system is converted into the information in the camera coordinate system. This process can be realized by a general coordinate conversion process. For example, in the case in which the control point in the object coordinate system is conveniently expressed in four dimensions like Pₒ=(Xₒ, Yₒ, Zₒ, 1), the position of the object in the camera coordinate system is expressed as T_{c} (three-dimensional vector), and the attitude is expressed as R_{c} (3×3 matrix), the coordinate P_{c}=(X_{c}, Y_{c}, Z_{c}, 1) of the control point in the camera coordinate system is expressed as Formula 1 below. It should be noted that 0^{T} in Formula 1 represents a zero vector of 3×1.

$$\begin{matrix}Formula 1 & \\ {P}_{c} = [ \begin{matrix}{R}_{c} & {T}_{c} \\ {0}^{T} & 1\end{matrix} ] {P}_{o} & ( 1 )\end{matrix}$$

According to the process described above, the control point input is expressed in the camera coordinate system. In other words, the information of the control point thus converted reflects the position attitude of the object with respect to the imaging section, and is therefore the information which can directly be used in the control such as the visual servo control.

### 3.5. Perspective Transformation Calculation Section

Due to the process in the camera coordinate conversion calculation section 1173, the three-dimensional coordinate information of the control point in the camera coordinate system has been obtained. In the visual servo control, it is possible to directly use the three-dimensional information as an element of the feature amount f.

It should be noted that it is assumed that in the present embodiment, the information of the three-dimensional control point is further converted into information on a predetermined image plane. In other words, it is also possible for the control section 110 to perform the perspective transformation on the control point in the camera coordinate system, and then make the arm operate using the information of the control point, on which the perspective transformation has been performed, as the feature amount. It should be noted that as described later as a modified example, the information obtained by the perspective transformation can also be used as the object feature amount.

FIG. 12 shows a schematic diagram of the perspective transformation. If the coordinate P_{c}=(X_{c}, Y_{c}, Z_{c}) of the control point in the camera coordinate system has been obtained, the coordinate Pᵢ=(x,y) of the control point in the image plane coordinate system (two-dimensional coordinate system) can be obtained using Formula 2 below.

$$\begin{matrix}Formula 2 & \\ [ \begin{matrix}x \\ y\end{matrix} ] = [ \begin{matrix}{f}_{c} \frac{{X}_{c}}{{Z}_{c}} \\ {f}_{c} \frac{{Y}_{c}}{{Z}_{c}}\end{matrix} ] & ( 2 )\end{matrix}$$

Assuming that the image plane corresponds to the imaging plane of the camera, f_{c} in Formula 2 above represents the focal distance of the camera. It should be noted that since it is sufficient in the present embodiment that the information of the three-dimensional control point can be projected on a predetermined image plane, it is sufficient to use an arbitrary value as f_{c}.

According to the process described above, the two-dimensional feature amount can be obtained from the single control point. If the three points P0 through P2 are set as the control points as shown in FIG. 9, it results that the feature amount f=(x0, y0, x1, y1, x2, y2) in six dimensions in total is obtained.

If the feature amount can be obtained, the subsequent process is substantially the same as the general visual servo control described above, and therefore, the detailed explanation will be omitted.

### 3.6. Modified Examples

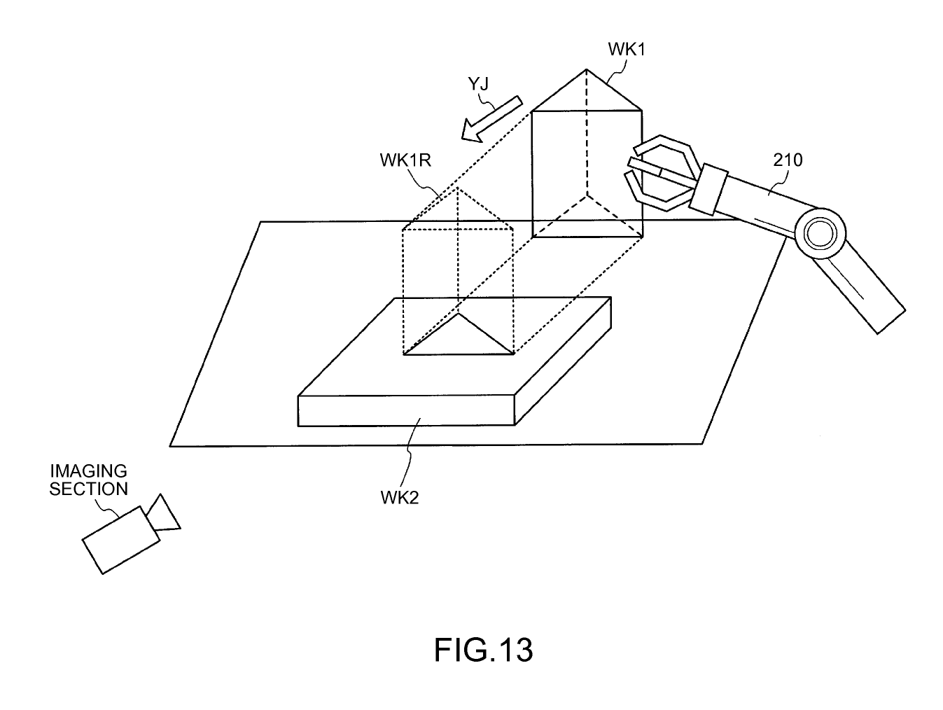

There is considered a robot operation of attaching a predetermined attachment object WK1 to another attachment target object WK2 as shown in FIG. 13. In the case of performing such an attachment operation as shown in FIG. 13 with the visual servo control using the reference image, the robot is controlled based on the taken image taken by the camera (the imaging section) and the reference image having been prepared in advance. Specifically, the attachment object WK1 is moved toward the position of the attachment object WK1R showing up in the reference image as indicated by the arrow YJ, and is then attached to the attachment target object WK2.

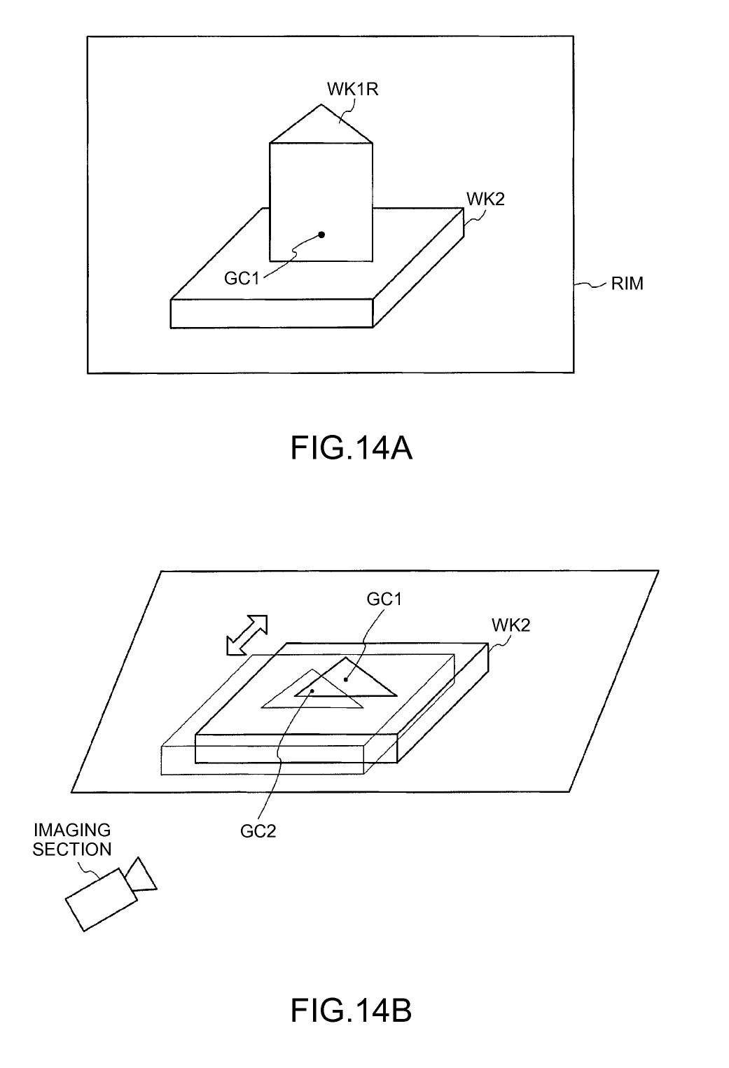

Here, FIG. 14A shows the reference image RIM used on this occasion, and FIG. 14B shows the position in the actual space (the three-dimensional space) of the attachment target object WK2 showing up in the reference image RIM. In the reference image RIM shown in FIG. 14A, the attachment object WK1R (corresponding to WK1R shown in FIG. 13) in the state in which the attachment object WK1R is attached to the attachment target object WK2 (or the state immediately before the attachment object WK1R is attached to the attachment target object WK2) shows up. In the visual servo control using the reference image RIM, the attachment object WK1 is moved so that the position attitude of the attachment object WK1 showing up in the taken image coincides with the position attitude of the attachment object WK1R showing up in the reference image RIM.

On this occasion, it is also possible to set the control point with reference to the attachment object WK1, and obtain the target feature amount from the information of the control point of the attachment object WK1 in the target state. However, in the attachment operation, it is possible to set the target feature amount with another method. Specifically, assuming that the state in which a predetermined vertex of the attachment object WK1 coincides with a predetermined vertex of the target attachment object WK2 is the target state of the attachment operation, it is also possible to set the vertex of the attachment object WK1 to a first control point, and set the vertex of the target attachment object WK2 to a second control point WK2.

On this occasion, for example, it is sufficient to obtain the feature amount (the control feature amount) used for each feedback loop from the first control point, and obtain the target feature amount from the second control point. In such a method as described above, if the control of approximating the control feature amount to the target feature amount is performed, it results that the vertex of the attachment object WK1 corresponding to the first control point is made to coincide with the vertex of the target attachment object WK2 corresponding to the second control point, and therefore, the desired attachment operation becomes possible.

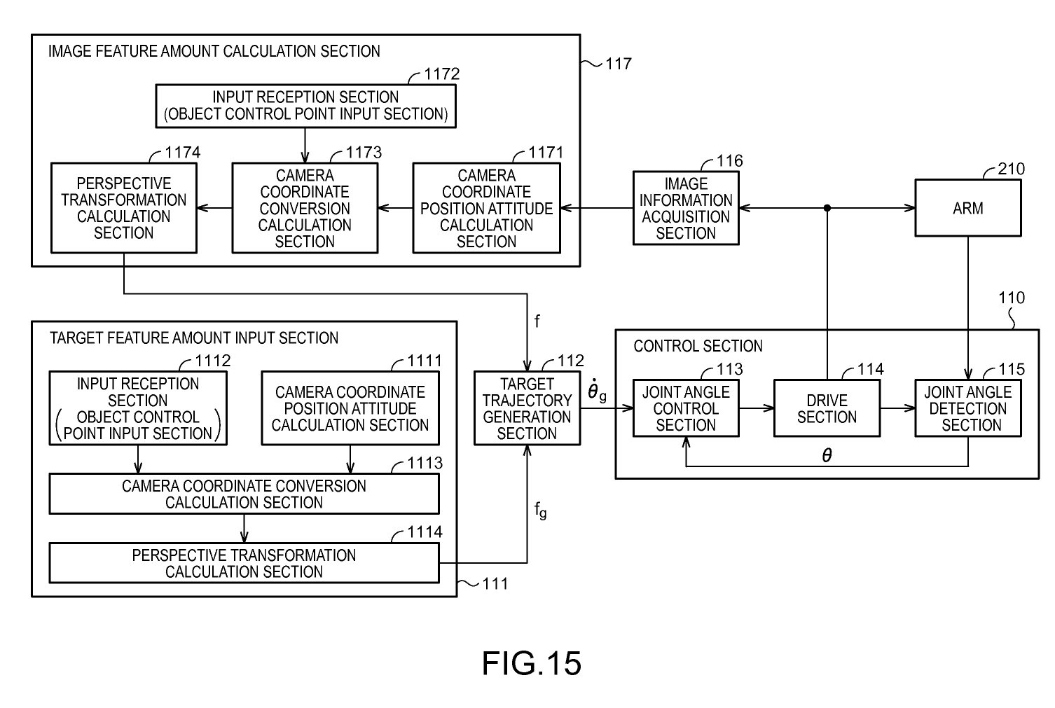

On this occasion, it is possible to perform the process of obtaining the target feature amount from the second control point using the method according to the present embodiment described above. Specifically, the input reception section (corresponding to an object control point input section 1112 described later using FIG. 15) receives the input of the information of the second control point defined by a second coordinate system set to a second object (the target attachment object WK2), and the control section 110 obtains the position attitude of the second object based on the information of the model of the second object and the taken image obtained by imaging the second object, and then obtains the target feature amount by performing the coordinate conversion of the second control point based on the position attitude of the second object. On this occasion, the coordinate conversion can include not only the conversion from the second object coordinate system to the camera coordinate system, but also the perspective transformation process.

FIG. 15 shows a system configuration example of the robot and so on in this case. In the case of comparison with FIG. 5, there is adopted a configuration in which the target feature amount input section 111 is added with a camera coordinate position attitude calculation section 1111, the object control point input section 1112, a camera coordinate conversion calculation section 1113, and a perspective transformation calculation section 1114. The process performed in each of the sections is the same as in the explanation described above except the point that the processing object is set to the target attachment object WK2, and therefore, the detailed explanation will be omitted. It should be noted that the configuration example of the robot is not limited to the example shown in FIG. 15. For example, the camera coordinate position attitude calculation section 1111 and so on perform substantially the same operations as in the camera coordinate position attitude calculation section 1171 and so on, and therefore, it is not required to separate each of these sections into two. Specifically, it is possible to adopt such a modified implementation as integrally configuring the camera coordinate position attitude calculation section 1111 and the camera coordinate position attitude calculation section 1171 with each other as a single block.

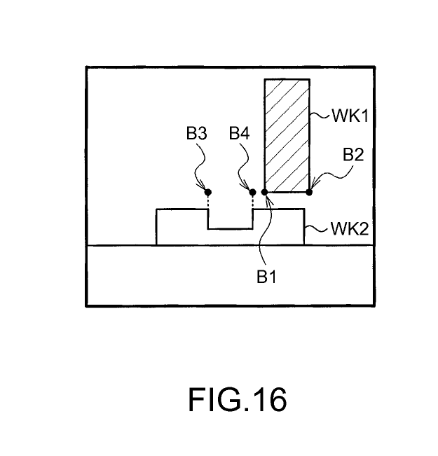

According to such a configuration, it is possible to flexibly set the control points for obtaining the feature amounts for both of the attachment object WK1 and the target attachment object WK2. For example, in the case of performing the control having a state immediately before completion of the attachment shown in FIG. 1D as the tentative target, although it is sufficient to set the control point outside the attachment object WK1 to obtain the control feature amount, and at the same time obtain the target feature amount using the vertex of the target attachment object WK2 as the second control point as described above, another modified implementation becomes possible. For example, as shown in FIG. 16, it is also possible to obtain the control feature amount using the vertex of the attachment object WK1 as the first control point, and at the same time obtain the target feature amount setting the second control point outside the target attachment object WK2. On this occasion, the control feature amounts are B1, B2 in the image, and the target feature amounts are B3, B4 in the image. By adopting this configuration, it is possible to perform substantially the same control as in the example shown in FIG. 1D. Besides the above, there become possible a variety of modified implementations such as setting the control point outside the attachment object WK1, and at the same time setting the second control point outside the target attachment object WK2, and obtaining the control feature amount and the target feature amount from the control points set outside the respective objects. In either case, it results that the control section 110 makes the arm 210 operate so that object and the second object become in a predetermined relative positional relationship based on the feature amount and the target feature amount.

It should be noted that if it is known that the relative position of the target attachment object WK2 with respect to the imaging section is fixed, it is sufficient for the process of obtaining the target feature amount from the second control point to be performed once, and subsequently, it is possible to continuously use the target feature amount thus obtained. However, in the case of actually performing the attachment operation, the position attitude of the target attachment object WK2 changes in some cases. For example, it is assumed that the centroid position of the target attachment object WK2 showing up in the reference image RIM shown in FIG. 14A corresponds to GC1 in the real space as shown in FIG. 14B. In contrast, in some cases, the actual target attachment object WK2 is placed in a shifted manner, and the centroid position of the actual target attachment object WK2 corresponds to GC2. In this case, even if the actual attachment object WK1 is moved so that the control feature amount and the target feature amount (the target feature amount having been obtained before the movement of the target attachment object WK2) coincide with each other, the attachment state with the actual target attachment object WK2 is not achieved, and therefore, the attachment operation cannot accurately be performed. This is because in the case in which the position attitude of the target attachment object WK2 has changed, the position attitude of the attachment object WK1 to be in the attachment state with the target attachment object WK2 also changes.

Therefore, in another modified example, it is also possible to obtain the target feature amount a plurality of times in a similar manner to the case of obtaining the control feature amount for each of the feedback loops. For example, it is also possible to obtain the target feature amount for each of the feedback loops, or to obtain the target feature amount once for a plurality of times of feedback loop, and a variety of modified implementations can be adopted.

By adopting such a configuration, even in the case in which the position attitude of the target attachment object WK2 changes, it becomes possible to perform accurate attachment operation.

Further, although in the above explanation, it is assumed that the control feature amount is obtained using the method according to the present embodiment, the invention is not limited to this assumption. For example, it is possible to achieve the control feature amount using the method of detecting a characteristic point in the image in a similar manner to the related art method, and obtain the target feature amount using the method according to the present embodiment.

Specifically, it is possible for the control section 110 to obtain the position attitude of the object based on the information of the model of the object (here, the target attachment object WK2, for example) and the taken image, then obtain the target feature amount by performing the coordinate conversion of the control point based on the position attitude, and then make the arm 210 operate using the target feature amount.

In this case, it results that the control section 110 obtains the feature amount based on the taken image obtained by imaging the second object (here, the attachment object WK1, for example), and then makes the arm 210 operate based on the feature amount and the target feature amount so that the object and the second object have a predetermined relative positional relationship.

By adopting this configuration, it becomes possible to flexibly set the control point for obtaining the target feature amount. In the case of performing, for example, the control shown in FIG. 16, even if it is possible to obtain the feature amount of the attachment object WK1 directly from the image, the desired operation cannot be performed unless the target feature amount is set outside the target attachment object WK2. In this regard, in the case of setting the target feature amount using the method according to the present embodiment, it is easy to dispose the control point outside the target attachment object WK2. Further, since the target feature amount is obtained using the position attitude of the target attachment object WK2 in the camera coordinate system, even in the case in which the position attitude of the target attachment object WK2 is displaced from a predetermined position attitude, it is possible to perform an appropriate operation.

### 4. Second Embodiment

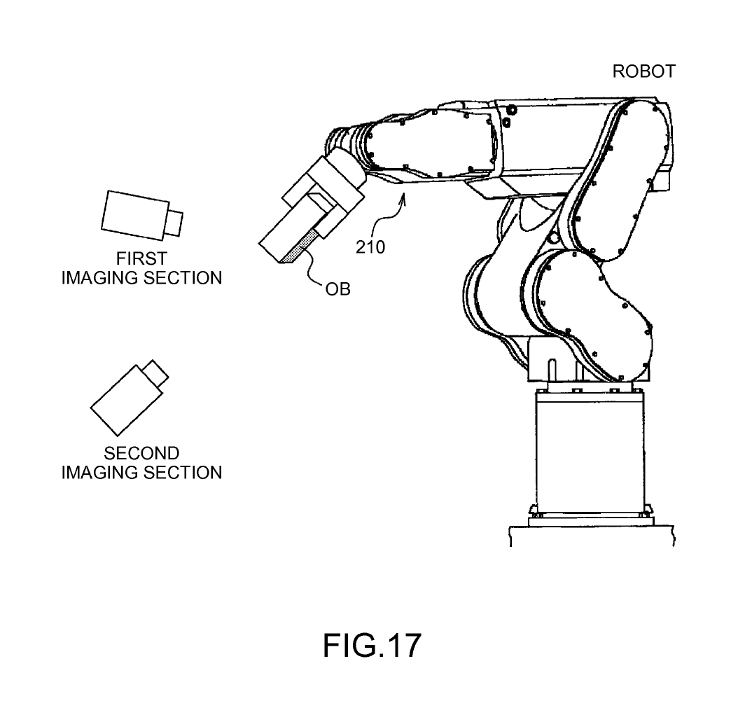

In the first embodiment and the modified examples of the first embodiment, it is assumed that the single imaging section is provided. It should be noted that it is possible for the control section 110 to make the arm 210 operate based on a first taken image taken by a first imaging section, a second taken image taken by a second imaging section, and the information input in the input reception section 1172. The configuration of the robot in this case is as shown in FIG. 17, for example.

As described hereinabove, when obtaining the feature amount (or the target feature amount), the process of obtaining the position attitude of the object in the camera coordinate system based on the taken image. However, since the estimation of the three-dimensional position attitude is performed based on the two-dimensional taken image, there is a possibility that the estimation includes an error.

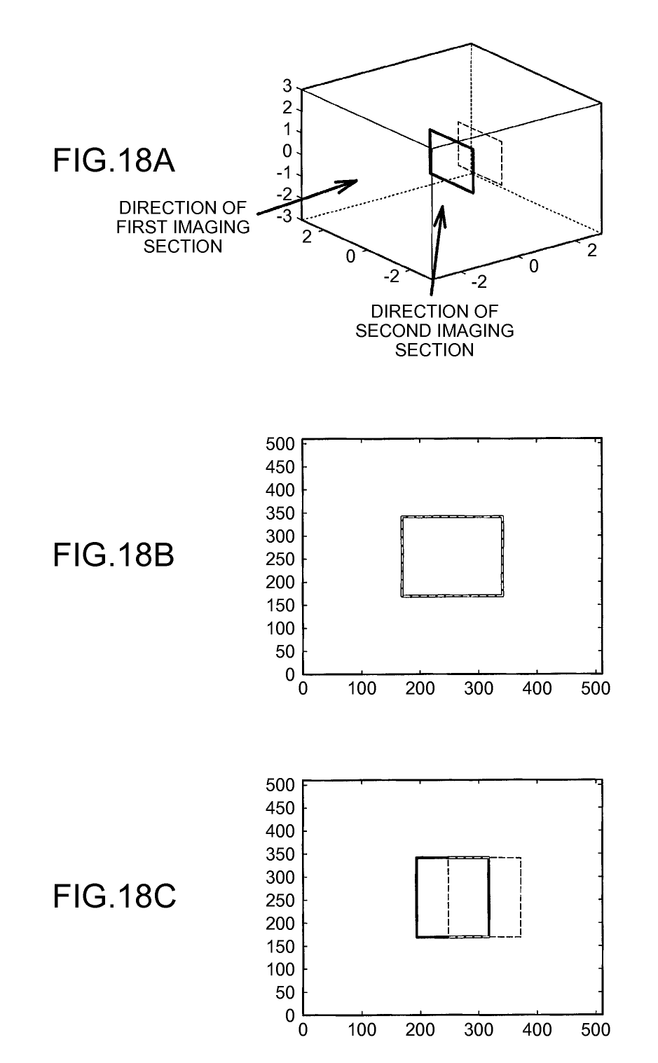

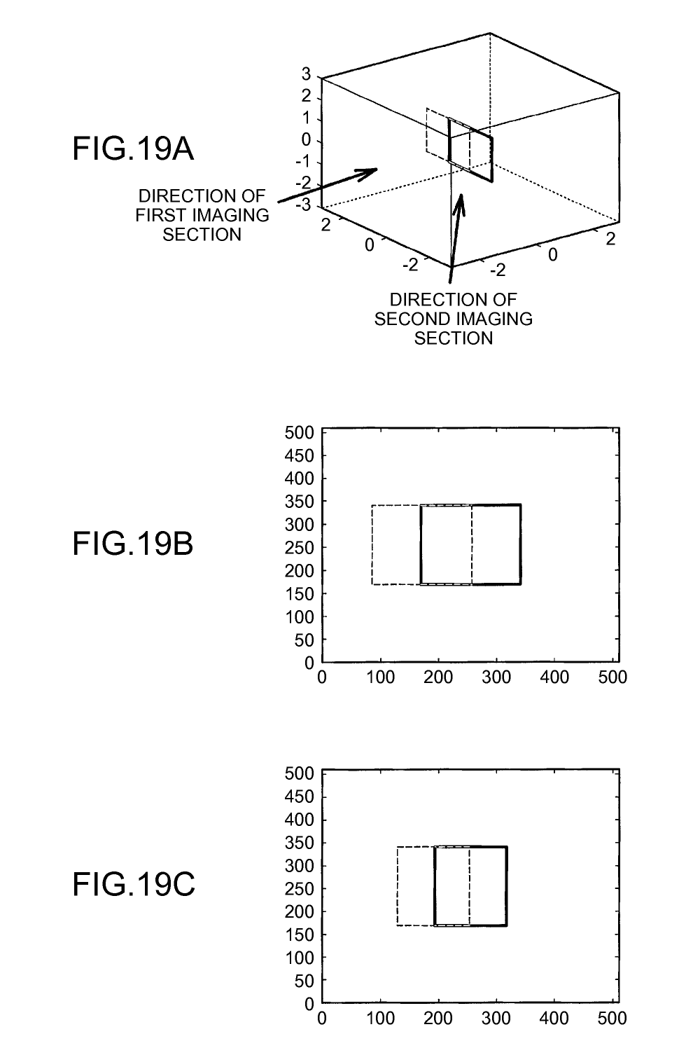

FIGS. 18A through 22C show some specific examples. FIG. 18A shows a spatial position attitude of the object (here, a planar object is assumed in order to simplify the explanation), wherein the solid line indicates the first position attitude, and the dotted line indicates a second position attitude different from the first position attitude. Further, FIG. 18B shows an example of the taken image in the case of imaging the object with the first and second position attitudes by the first imaging section for taking an image in the direction shown in FIG. 18A, and FIG. 18C shows an example of the taken image in the case of imaging the object by the second imaging section for taking an image in the direction shown in FIG. 18A. It should be noted that the point that the drawings show the relationship between the spatial position attitude of the object, the taken image by the first imaging section, and the taken image by the second imaging section is the same in FIGS. 19A through 22C.

In the example shown in FIG. 18A, the second position attitude is assumed to be the position attitude translated in the optical axis direction of the first imaging section with respect to the first position attitude. In this case, as is understood from FIG. 18B, despite the fact that the position attitude of the object has changed, the change in the object in the taken image by the first imaging section is very small. In contrast, as is understood from FIG. 18C, in the image taken by the second imaging section, the change of the position attitude of the object is clear in the taken image.

Similarly, in FIG. 19A, the second position attitude is assumed to be the position attitude translated in a direction different from either of the optical axis direction of the first imaging section and the optical axis direction of the second imaging section with respect to the first position attitude. In this case, despite the fact the the displacement itself is in roughly the same level as shown in FIG. 18A, the change in the taken image becomes clear as is understood from FIGS. 19B and 19C.

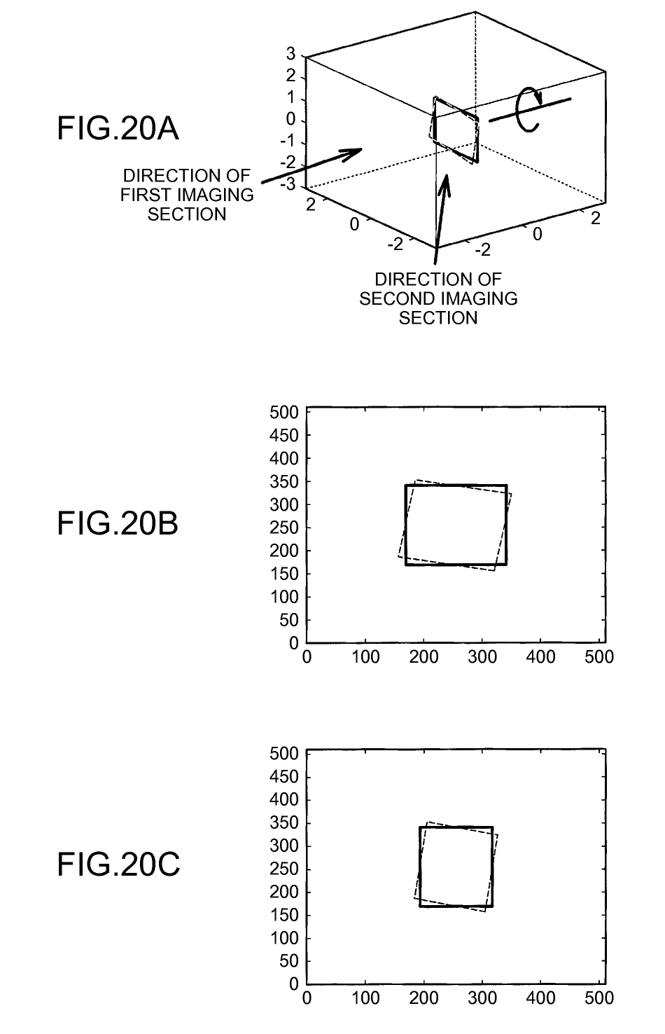

Further, in FIG. 20A, the second position attitude is assumed to be the position attitude rotated around the optical axis direction of the first imaging section with respect to the first position attitude. In this case, as is understood from FIGS. 20B and 20C, the changes in the taken image are clarified.

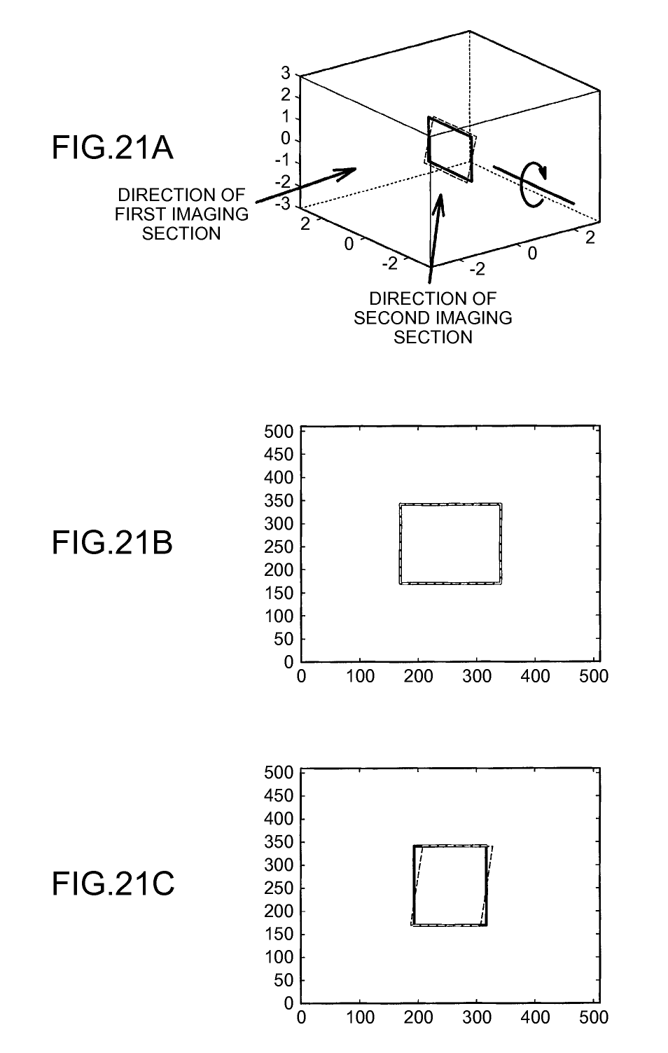

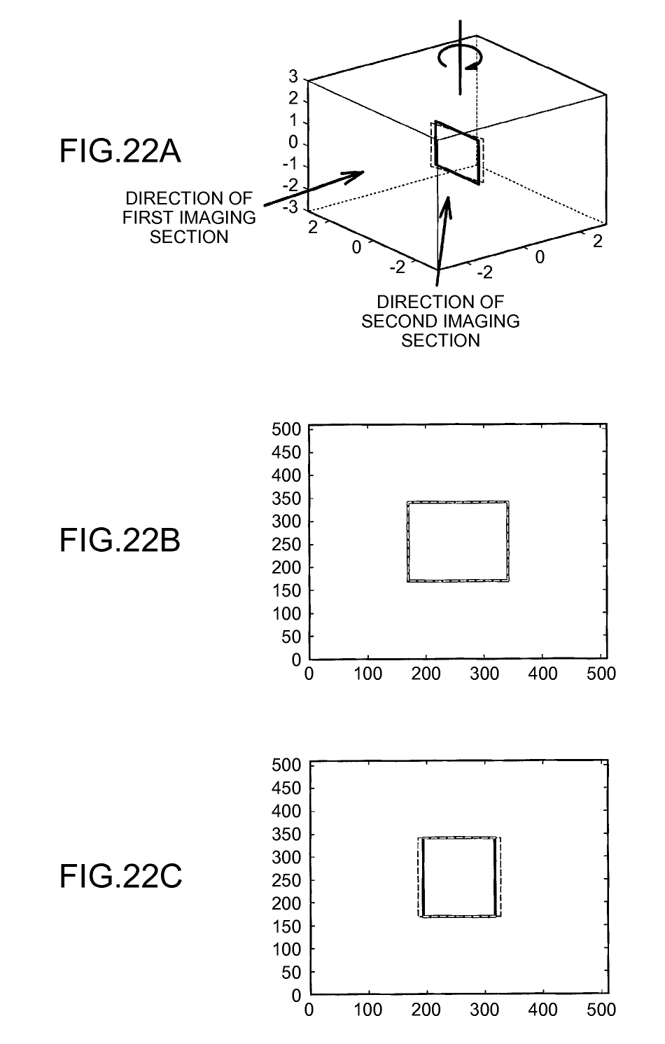

In contrast, in FIGS. 21A and 22A, the second position attitude is assumed to be the position attitude rotated around a direction perpendicular to the optical axis direction of the first imaging section with respect to the first position attitude. In this case, as is understood from FIGS. 21B and 22B, despite the fact that the position attitude of the object has changed, the change in the object in the taken image by the first imaging section is very small. In contrast, as is understood from FIGS. 21C and 22C, in the image taken by the second imaging section, the change of the position attitude of the object is clear in the taken image.

As is understood from FIGS. 18A, 18B, 21A, 21B, 22A, and 22B, in the case in which the translation in the optical axis direction of the imaging section or the rotation accompanied by the movement centered on the optical axis direction of the imaging section is performed, even if the three-dimensional position attitude of the object has changed, the change in the object in the taken image becomes very small. This shows the fact that it is difficult to accurately obtain the position in the optical axis direction and the rotation around the rotational axis perpendicular to the optical axis in estimating the position attitude of the object from the taken image. Specifically, in the case of FIG. 18A, as long as the difference between the solid line and the dotted line becomes very small in the taken image as shown in FIG. 18B even if the position attitude of the object has changed, there cannot be denied the possibility that the position attitude is erroneously detected as one indicated by the dotted line (the solid line) shown in FIG. 18A in the case in which the taken image indicated by the solid line (the dotted line) shown in FIG. 18B is obtained.

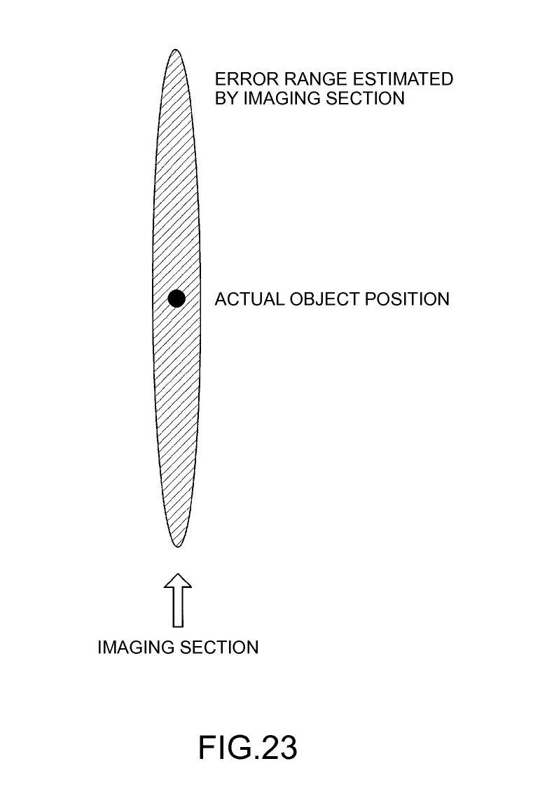

FIG. 23 schematically shows the error. As is understood from FIG. 23, the position attitude estimated from the taken image includes the error in the optical axis direction. Further, the position attitude calculated by the camera coordinate position attitude calculation section 1171 is obtained by calculating one position attitude, which has been determined to be probable within the error range, and therefore, high accuracy is not assured.

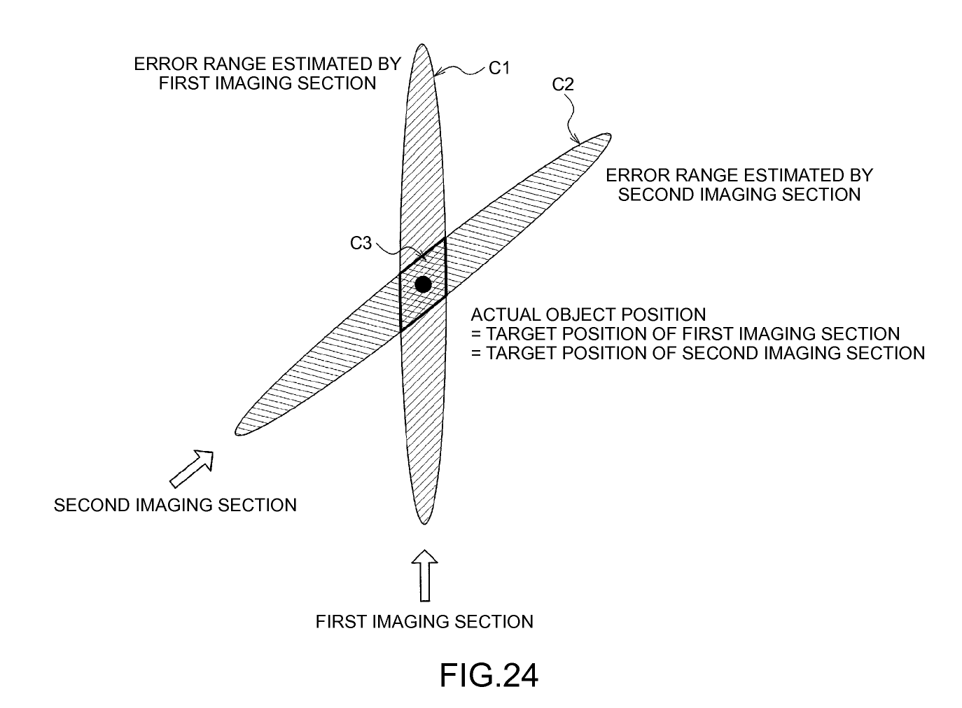

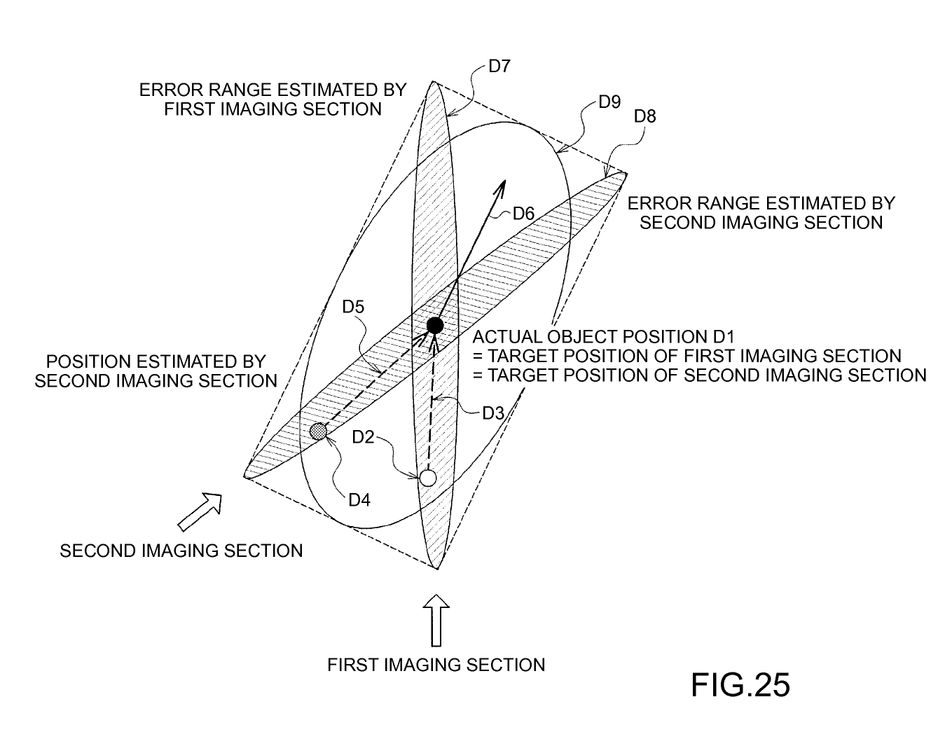

In contrast, it is possible to provide the second imaging section different in optical axis direction from the first imaging section. Regarding the second imaging section, although the calculation accuracy of the position attitude is not sufficient in the optical axis direction of the second imaging section, it becomes possible to achieve a highly accurate position attitude estimation that if an error range C1 of the first imaging section and an error range C2 of the second imaging section are identified, the position attitude of the object is in a range C3 as an overlapping range between the error range C1 and the error range C2 as shown in FIG. 24. It should be noted that in FIG. 24, only the position of the object is shown and the attitude of the object is omitted in order to simplify the explanation. This point applies to FIGS. 25, 27, and 28.

It should be noted that the case in which such an estimation as shown in FIG. 24 is available is limited to the case in which the control section 110 knows the relative positional relationship between the first imaging section and the second imaging section. In other words, it becomes possible to obtain the overlapping range C3 shown in FIG. 24 precisely because the control section 110 knows the relationship that if the object is located at a certain position, the object is imaged by the first imaging section at a certain position, and is imaged by the second imaging section at a certain position. In other words, if the relative relationship between the two imaging sections is unknown, it is not achievable to integrally process the information obtained by one of the imaging sections and the information obtained by the other of the imaging sections with each other. Therefore, even if the number of imaging sections is simply increased, it cannot be said that it is advantageous in terms of accuracy. In order to make the positional relationship between the two imaging sections known, it is necessary to accurately dispose the imaging sections in the operation environment of the robot. Alternatively, it is necessary to perform an extremely complex calibration operation of changing the attitude of a board or the like provided with a specific pattern while keeping the board showing up in the two imaging sections at the same time. The recent development of the robot is in the direction of aiming at the state in which even the user without expert knowledge can easily use the robot. Therefore, in many cases, it is not preferable to force the user to accurately dispose the imaging sections, or to perform the complex calibration operation, and it can be said that the circumstance that the relative positional relationship between the imaging sections is unknown can considerably occur as a result.

Moreover, in the case of using a plurality of imaging sections in the state in which the relative relationship is unknown, there is a possibility that the errors, which can be generated in the processes in the respective imaging sections, are accumulated to cause a larger error. FIG. 25 shows a specific example. FIG. 25 shows an example of the case in which the object reaches the position to be the target. Since the object is located at the target position D1, it is obvious that there is no need to further move the object with the visual servo control, and the required displacement should ideally be 0. In contrast, in the first imaging section, since the estimation accuracy in the optical axis direction is low, the object properly located at D1 is falsely detected to be located at D2. Therefore, it results that the control amount for moving the object as much as the vector indicated by D3 is output from the processing of the first imaging section. Similarly, also in the second imaging section, the object properly located at D1 is falsely detected to be located at D4. Therefore, it results that the control amount for moving the object as much as the vector indicated by D5 is output from the processing of the second imaging section. As a result, the control of moving the object as much as D6 corresponding to the resultant vector of D3 and D5 is performed using the visual servo control.

Specifically, in the case in which the error range corresponding to D7 is generated in the first imaging section, the error range corresponding to D8 is generated in the second imaging section, and it is determined to treat the results independently of each other, it is necessary to consider the range corresponding to D9 determined from D7 and D8 as the error range of the final control amount.

However, according to the method of the present embodiment described hereinabove, even in the case in which the relative relationship between the first and second imaging sections is unknown, and the respective processes are performed independently of each other, it becomes possible to perform the processes with high accuracy without accumulating the errors as shown in FIG. 25. This is because as shown in FIG. 12, in the present embodiment, the position attitude of the control point in the camera coordinate system is obtained, and then the perspective transformation into the image plane coordinate system is performed on the information of the control point. Thus, the contribution of the information in the optical axis direction low in accuracy is lowered, and therefore, it becomes possible to avoid the deterioration of the accuracy. The detailed explanation will hereinafter be presented.

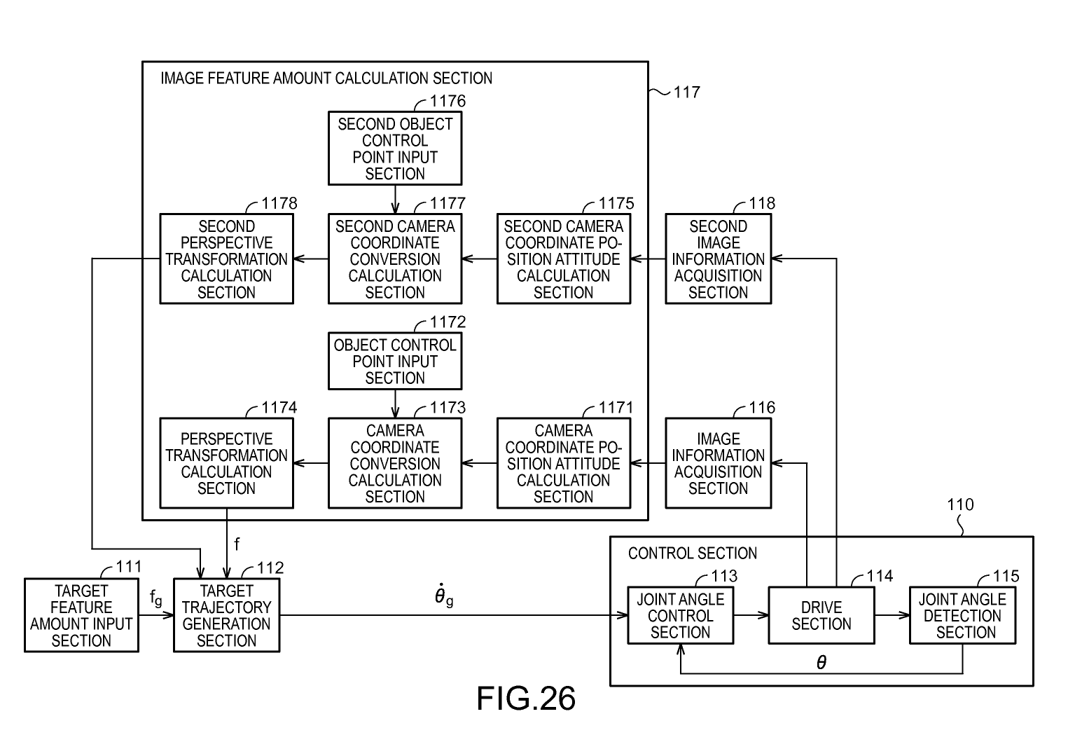

Firstly, FIG. 26 shows a system configuration example of the robot in this case. In the case of the comparison with FIG. 5, there is provided a configuration in which a second image information acquisition section 118 is added, and at the same time, the image feature amount calculation section 117 is further added with a second camera coordinate position attitude calculation section 1175, a second object control point input section 1176, a second camera coordinate conversion calculation section 1177, and a second perspective transformation calculation section 1178. The second image information acquisition section 118 obtains the second taken image from the second imaging section, and the second camera coordinate position attitude calculation section 1175, the second object control point input section 1176, the second camera coordinate conversion calculation section 1177, and the second perspective transformation calculation section 1178 perform the respective processes described above targeting the second taken image. The processing contents of the second camera coordinate position attitude calculation section 1175, the second object control point input section 1176, the second camera coordinate conversion calculation section 1177, and the second perspective transformation calculation section 1178 are the same respectively as those of the camera coordinate position attitude calculation section 1171, the object control point input section 1172, the camera coordinate conversion calculation section 1173, and the perspective transformation calculation section 1174. Further, it is also possible to commonly use these sections instead of dividing each of these sections into two.

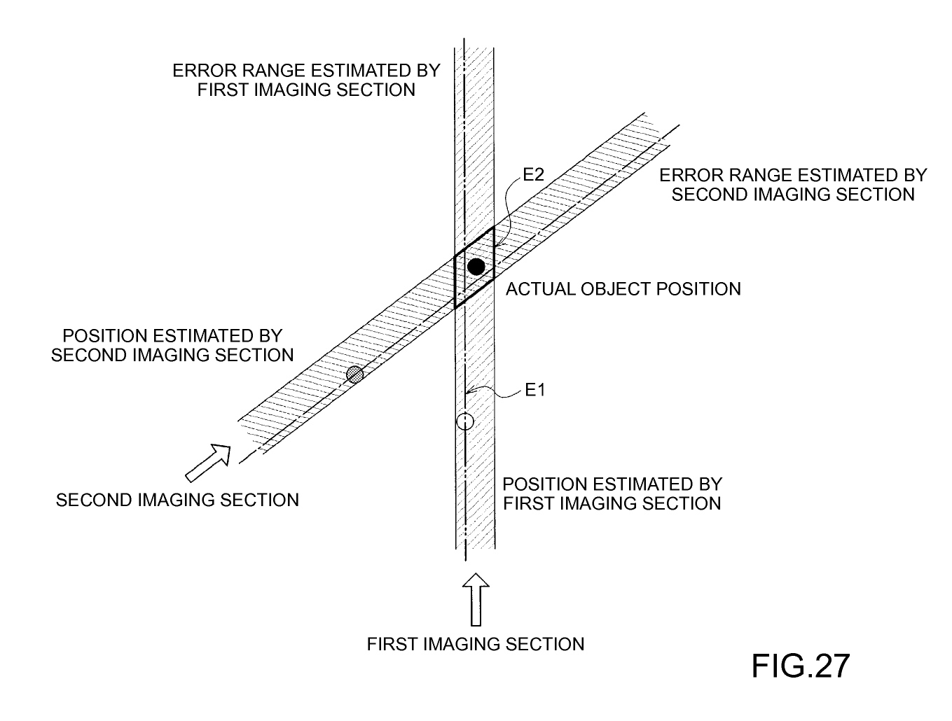

In the perspective transformation calculation section 1174, the information of the three-dimensional control point expressed with the camera coordinate system (a first camera coordinate system) corresponding to the first imaging section is transformed into the information of the two-dimensional image plane coordinate system with the process shown in FIG. 12. The information of the control point in the camera coordinate system corresponds to the process of estimating the probable one point out of the error range as shown in FIG. 25. In contrast, the information of the control point on which the perspective transformation has been performed corresponds to the estimation that the control point corresponds to any point on the straight line as indicated by E1 in FIG. 27 without limiting the position in the optical axis direction.

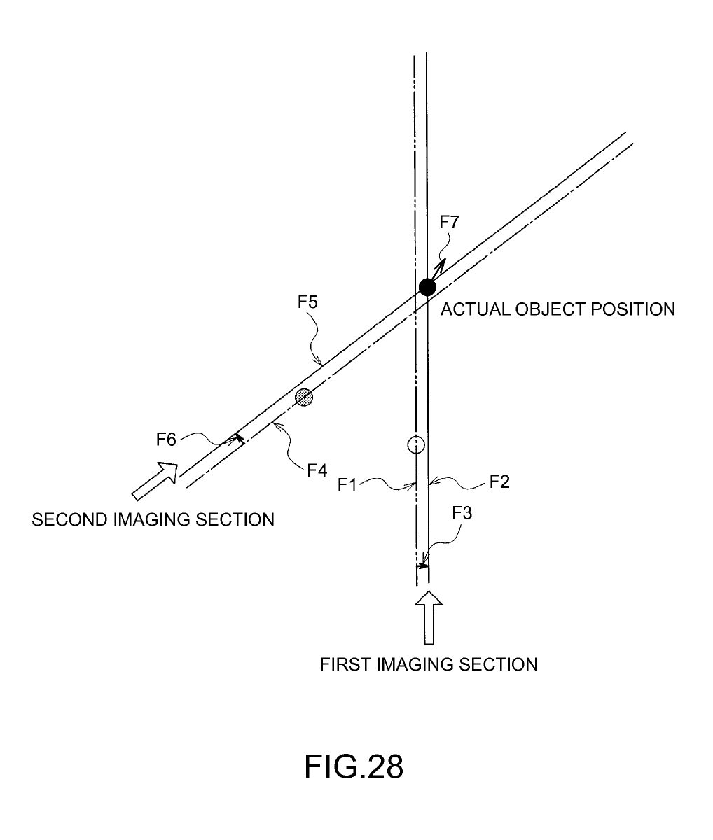

In this case, the position (the target feature amount) of the control point in the target state is also expressed as a straight line (a target line). Specifically, as shown in FIG. 28, in the case of viewing from the first imaging section, the current position is expressed by the straight line F1, and the target position is expressed by the target line F2. Therefore, if attempting to reduce the difference using the visual servo control, there can be obtained the output having the vector F3 for making the straight lines coincide with each other as the control amount. Similarly, in the case of viewing from the second imaging section, the current position is expressed by the straight line F4, and the target position is expressed by the target line F5. Therefore, in the visual servo control, there can be obtained the output having the vector F6 for making the straight lines coincide with each other as the control amount.

As a result, the control of moving the object as much as F7 corresponding to the resultant vector of F3 and F6 is performed using the visual servo control. As is understood from FIG. 28, despite the circumstance similar to FIG. 25, by performing the perspective transformation process in advance, it becomes possible to suppress the accumulation of the errors. Specifically, as the error range, it is sufficient to consider the area indicated by E2 shown in FIG. 27 instead of D9 shown in FIG. 25.

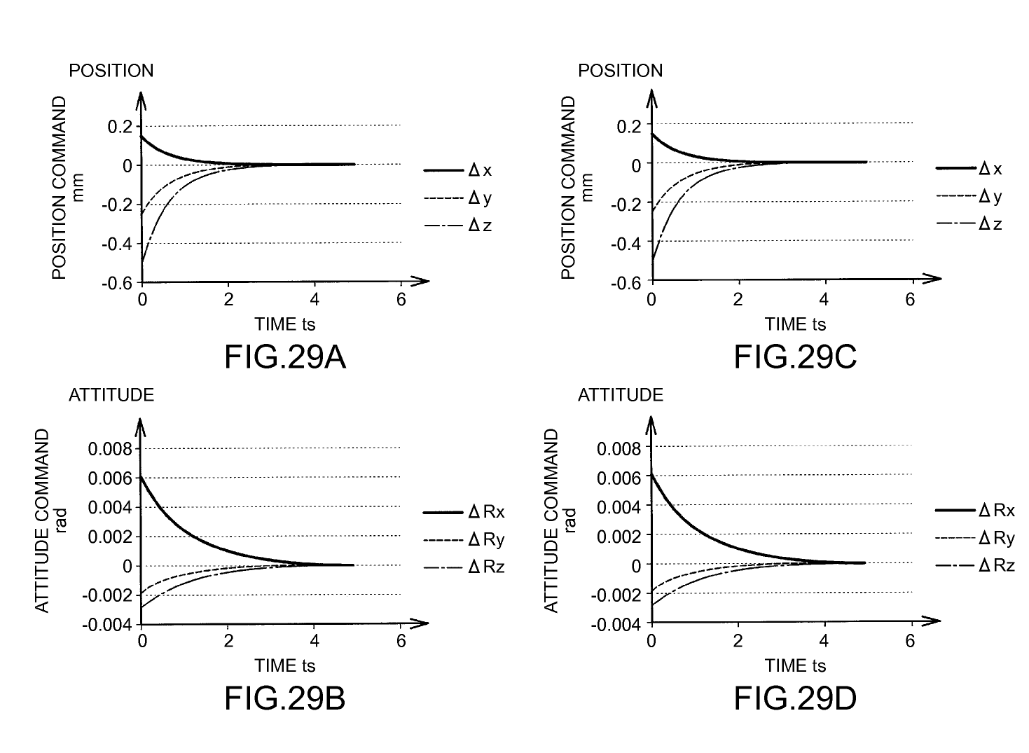

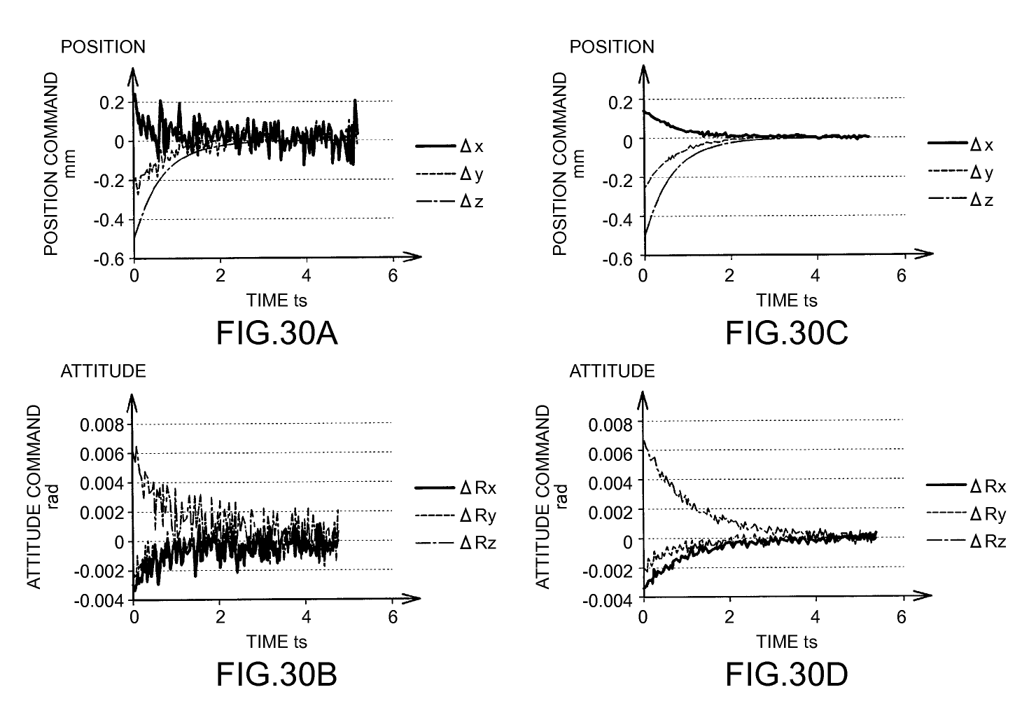

FIGS. 29A through 30D show the simulation result representing the result described above. FIGS. 29A through 29D show the control amount (the variation target amount of the position attitude of the object for every cycle of the visual servo control) of the visual servo control in the circumstance assuming that no error exists. Specifically, FIGS. 29A and 29B show the change of the target variation of the position of the object with time and the change of the target variation of the attitude of the object with time, respectively, in the case of using the position attitude (the output or the like of the camera coordinate position attitude calculation section 1171) in the camera coordinate system as the feature amount. In other words, FIGS. 29A and 29B show the state of the visual servo control in the case in which the perspective transformation process is not performed. In contrast, FIGS. 29C and 29D show the change of the target variation of the position of the object with time and the change of the target variation of the attitude of the object with time, respectively, in the case of using the information of the control point in the image plane coordinate system after the perspective transformation process has been performed as the feature amount.

As is understood from FIGS. 29A through 29D, in the ideal circumstance in which the consideration of the error is not required, the feature amount shows the same tendency between the case of using the information on which the perspective transformation process has not been performed and the case of using the information on which the perspective transformation process has been performed. Specifically, the variation of the position or the attitude gradually decreases, and then the target variation converges on 0 when the target position attitude is reached.

In contrast, FIGS. 30A through 30D show the example of the case in which the error exists, wherein the information on which the perspective transformation process has not been performed is used as the feature amount in FIGS. 30A and 30B, and the information on which the perspective transformation process has been performed is used as the feature amount in FIGS. 30C and 30D. In this case, as is understood from FIGS. 30A and 30B, if it is assumed that the perspective transformation process is not performed, the instruction of the variation of the position attitude is not converged on 0, and the state in which the degree of the fluctuation is high continues. This is because as shown in FIG. 25, even if the target state is approached, it is attempted to dramatically change the position attitude.

In contrast, in the case of using the information on which the perspective transformation has been performed as the feature amount as shown in FIGS. 30C and 30D, since the error is suppressed to a low level as shown in FIG. 27, it becomes possible to suppress the degree of the fluctuation of the control amount to a low level to perform the accurate control. In other words, by performing the perspective transformation process, accurate robot operation becomes possible without precisely setting the relationship between the two or more imaging sections. Therefore, it is possible to reduce the load of the user using the robot, and it becomes possible for the user not provided with the expert knowledge, for example, to easily realize a desired robot operation.

Although the two embodiments, namely the first and second embodiments, to which the invention is applied, and the modified examples of the embodiments are hereinabove explained, the invention is not limited to the first and second embodiments and the modified examples of the embodiments, but can be implemented with the constituents modified within the scope or the spirit of the invention in the practical phase. Further, by arbitrarily combining the plurality of constituents disclosed in each of the first and second embodiments and the modified examples described above, a variety of related inventions can be constituted. For example, it is also possible to remove some constituents out of all of the constituents described in each of the first and second embodiments and the modified examples. Further, it is also possible to arbitrarily combine the constituents explained in the embodiments and the modified examples different from each other. Further, a term described at least once with a different term having a broader sense or the same meaning in the specification or the accompanying drawings can be replaced with the different term in any part of the specification or the accompanying drawings. As described above, a variety of modifications and applications can be made within the scope or the spirit of the invention.

The entire disclosure of Japanese Patent Application No. 2014-121217, filed Jun. 12, 2014 is expressly incorporated by reference herein.

What is claimed is:

1. A robot comprising:
an arm adapted to move an object;
an input reception section adapted to receive input of information defined by a coordinate system set to the object; and
a control section adapted to make the arm operate based on a taken image obtained by imaging the object and the information input.

2. The robot according to claim 1, wherein
the input reception section receives the input of the information in a screen in which a model corresponding to the object is displayed.

3. The robot according to claim 1, wherein
the information is information of a control point defined by the coordinate system set to the object.

4. The robot according to claim 3, wherein
the control section
obtains position attitude of the object based on information of a model of the object and the taken image,
obtains a feature amount by performing a coordinate conversion of the control point based on the position attitude, and
makes the arm operate based on the feature amount and a target feature amount.

5. The robot according to claim 4, wherein
the input reception section receives input of information of a second control point defined by a second coordinate system set to a second object, and
the control section
obtains position attitude of the second object based on information of a model of the second object and the taken image obtained by imaging the second object, and
performs the coordinate conversion of the second control point based on the position attitude of the second object to thereby obtain the target feature amount.

6. The robot according to claim 5, wherein
the control section makes the arm operate so that the object and the second object have a predetermined relative positional relationship based on the feature amount and the target feature amount.

7. The robot according to claim 3, wherein
the control section
obtains position attitude of the object based on information of a model of the object and the taken image,
obtains a target feature amount by performing a coordinate conversion of the control point based on the position attitude, and
makes the arm operate using the target feature amount.

8. The robot according to claim 7, wherein
the control section
obtains a feature amount based on the taken image obtained by imaging the second object, and
makes the arm operate so that the object and the second object have a predetermined relative positional relationship based on the feature amount and the target feature amount.

9. The robot according to claim 1, wherein
the information is information of a control point defined by the coordinate system set to the object, and
the control section
obtains the position attitude of the object in a camera coordinate system set to an imaging section adapted to take the taken image based on information of a model of the object and the taken image, and
obtains information of the control point in the camera coordinate system based on the position attitude in the camera coordinate system and information of at least one control point in the coordinate system set to the object.

10. The robot according to claim 9, wherein
the control section performs perspective transformation on the control point in the camera coordinate system, and makes the arm operate using information of the control point, on which the perspective transformation has been performed, as at least one of the feature amount and a target feature amount.

11. The robot according to claim 1, wherein
the control section makes the arm operate based on a first taken image taken by a first imaging section, a second taken image taken by a second imaging section, and the information input.

12. A robotic system comprising:
a robot including an arm adapted to move an object;
an input reception section adapted to receive input of information defined by a coordinate system set to the object; and
a control section adapted to make the arm operate based on a taken image obtained by imaging the object and the information input.

13. A control device adapted to control a robot including an arm adapted to move an object, comprising:
an input reception section adapted to receive input of information defined by a coordinate system set to the object; and
a control section adapted to make the arm operate based on a taken image obtained by imaging the object and the information input.
